(19) United States
(12) Patent Application Publication
(10) Pub. No.: US 2025/0384427 A1
(43) Pub. Date: Dec. 18, 2025

(54) METHOD AND SYSTEM FOR FACILITATING A SECURE TRANSFER OF ASSETS

(71) Applicant: CONCEPT TECHNOLOGY AG, Steinhausen (CH)

(72) Inventors: Zhe YANG, Herrliberg (CH); Yali XU, Herrliberg (CH)

(21) Appl. No.: 19/109,324

(22) PCT Filed: Sep. 7, 2023
(86) PCT No.: PCT/EP2023/074680

§ 371 Date: Mar. 6, 2025

(30) Foreign Application Priority Data
Sep. 7, 2022 (EP) 22194456.4

(51) Int. Cl. G06Q 20/36

(52) U.S. Cl. CPC G06Q 20/367

(57) ABSTRACT

A computer implemented method, devices, and a system is disclosed for facilitating a secure transfer of cryptocurrency between two Blockchain platforms (C1, C2), the method comprising monitoring the first Blockchain platform (C1), by a computerized channel relay server (1), for a transaction directed to a particular smart contract on the first Blockchain platform (C1), verifying whether the transaction has been confirmed, and transmitting transaction confirmation information to the second Blockchain platform (C2), such that the cryptocurrency is made available on the second Blockchain platform (C2).

### FIELD OF THE DISCLOSURE

The present disclosure relates to methods and systems for facilitating a secure transfer of assets between two Blockchain platforms. Specifically, the present disclosure relates to methods and systems for facilitating a secure transfer of cryptocurrency between two Blockchain platforms, whereby a channel relay server monitors two Blockchain platforms, each having a smart contract for transferring a defined number of tokens of a particular cryptocurrency between a first Blockchain platform and a second Blockchain platform.

### BACKGROUND OF THE DISCLOSURE

With Bitcoin a first cryptocurrency was implemented on the first Blockchain platform. More cryptocurrencies and various further Blockchain platforms, for example Ethereum, were developed and implemented thereafter, adding more features and functions, such as smart contracts, and making the use and applications of cryptocurrencies more popular worldwide among increasingly diverse users. While each Blockchain platform has a native cryptocurrency, for example, Bitcoin on the Bitcoin Blockchain, or Ether on the Ethereum platform, many Blockchain platforms support the issuance of further non-native cryptocurrencies, for example, cryptocurrencies according to the ERC-20 standard have proven to be popular on the Ethereum platform. These non-native cryptocurrencies are enabled by so-called smart-contracts or similar scripting capabilities on these Blockchain platforms.

Blockchain platforms are—explained most simply—append-only ledgers whose entries comprise transactions from one address to another. These addresses identify a particular digital wallet related to an owner entity, for example a person or a company. These addresses can alternatively identify a smart contract, the smart contract having scripting functionality and internal data. The scripting functionality of the smart contracts is limited due to the limitations in the computational capabilities of Blockchain platforms. A smart contract on a particular Blockchain platform can interact directly only with the Blockchain platform itself, in particular by receiving transactions from addresses, sending transactions to addresses, or interacting with other smart contracts. On some Blockchains, smart contracts can interact with each other by calling a function of another smart contract (i.e. executing code stored in another smart contract).

Non-native cryptocurrencies are, unlike the native cryptocurrency, not held directly in digital wallets, but each managed by one or more particular cryptocurrency smart contracts which are responsible for the creation and book-keeping of the particular cryptocurrency. In particular, each cryptocurrency smart contract maintains a database of addresses and their respective balances, each address being associated with a digital wallet or a smart contract, each address being associated with an owner entity. The owner entity can transfer a particular number of tokens of a cryptocurrency to a recipient by sending a transaction to the cryptocurrency smart contract, wherein the transaction defines the recipient address and a number of cryptocurrency tokens to be transmitted. These transactions result in the cryptocurrency smart contract updating its internal database. However, such transactions are limited in that they only allow for the cryptocurrency to be transmitted to a recipient on the same Blockchain platform as the sender.

Some types of cryptocurrencies are available on multiple Blockchain platforms, each Blockchain platform having one or more cryptocurrency smart contracts involved in issuing and managing that particular type of cryptocurrency token. For example, both the Blockchain Ethereum and the Blockchain Alogrand have a cryptocurrency token called USD Coin (USDC), which is a digital stablecoin pegged to the United States Dollar. Other cryptocurrencies on a particular Blockchain platform have an equivalent cryptocurrency available on a different Blockchain platform. These include so-called pegged cryptocurrencies. For example, while Bitcoin (BTC) is available only on the Bitcoin Blockchain platform, Ethereum has a wrapped Bitcoin (WBTC), which is equivalent to BTC in that it is designed to be exchangeable 1:1 for BTC.

When two parties agree to exchange cryptocurrency on a first Blockchain platform with cryptocurrency on a second Blockchain platform, i.e. a first party sends cryptocurrency on the first Blockchain to the second party and in return receives cryptocurrency on the second Blockchain from the second party, a third party is typically used to reduce the counterparty risk. This is because Blockchain platforms cannot directly interact with each other and therefore the transacting parties cannot make the transactions directly contingent on each other. The third party acts, for example, as an escrow, temporarily holding the cryptocurrencies to be exchanged from both parties involved in the transaction and then releasing the cryptocurrencies to the appropriate party once both parties have transmitted their cryptocurrency to the escrow. While this process reduces the risk, there is still a remaining risk related to the third party because the third party may keep the cryptocurrency tokens for itself or may be unable to timely release the funds, for example because of a technical interruption. Additionally, this process can take a long time because the escrow may need to wait until the first transactions (from the parties to the escrow) are confirmed on the Blockchain platforms before releasing the funds. Depending on the type of Blockchain platform and timeouts and wait times in the process set out by the escrow, this can take over an hour.

Other examples of methods for transferring cryptocurrency tokens from one Blockchain platform to another involve asset bridges, where users transfer a number of cryptocurrency tokens to an address associated with a first gateway contract for escrow purposes on a first Blockchain, then wait for a second gateway contact on the second Blockchain to transfer the same number of cryptocurrency tokens to their address on the second Blockchain. However, this method still involves a considerable counterparty risk because there is a brief moment where the user is not in possession of their cryptocurrency, but rather relies on those responsible for the gateway contracts not to steal their cryptocurrency and additionally relies on the computing infrastructure monitoring the gateway contracts not to fail.

There is therefore a need to provide a method and system for transferring cryptocurrency from one Blockchain platform to another, which has greater speed and reliability and reduces the counterparty risks.

### SUMMARY OF THE DISCLOSURE

It is therefore an object of the present disclosure to provide a method and apparatus for transferring digital assets between two Blockchain platforms which does not have at least some of the disadvantages of the prior art.

According to the present disclosure, these objects are achieved through the features of the independent claims. In addition, further advantageous embodiments follow from the dependent claims and the description.

It is therefore an object of the present disclosure to provide a computer implemented method for facilitating a secure transfer of digital assets between two Blockchain platforms. The method comprises monitoring, by a processor of a channel relay server, a first Blockchain platform for a chain-one-to-channel data transaction. The chain-one-to-channel data transaction comprises: a defined target address of a first smart contract, a defined number of tokens of a particular cryptocurrency, and a first digital signature. A first address of the owner entity is derivable either from the first digital signature of the chain-one-to-channel data transaction, or derivable from the transaction instructions of the chain-one-to-channel data transaction. Optionally, the chain-one-to-channel data transaction comprises a recipient address on a second Blockchain platform. The method comprises verifying, by the processor, whether the chain-one-to-channel data transaction has been confirmed on the first Blockchain platform. The method comprises transmitting, by the processor, transaction confirmation information to a second smart contract on a second Blockchain platform, in case of affirmative confirmation of the chain-one-to-channel data transaction.

The channel relay server is a computer system communicatively connected to the first Blockchain platform and the second Blockchain platform and configured to interact with the first Blockchain platform and the second Blockchain platform.

The channel relay server enables and/or at least in part implements a channel (more specifically, a cryptocurrency payment channel) for the owner entity, enabling the owner entity to securely transfer tokens of the cryptocurrency from the first Blockchain platform to the second Blockchain platform. The channel is a data object or data structure which represents and/or enables the channeling of cryptocurrency tokens from the first Blockchain platform to the second Blockchain platform, and optionally vice versa. The channel may also store a total balance of tokens associated with the owner entity. The owner entity may, as described herein, withdraw tokens of the cryptocurrency from the channel to either the first Blockchain platform and/or the second Blockchain platform. The total balance may also be understood as a channel balance, in particular a current total channel balance. The total balance may change over time according to deposits and withdrawals. The total balance may be computed and/or recomputed at any time using the data transactions on the first Blockchain platform and/or the second Blockchain platform, in particular those data transactions associated with the owner entity and/or the first and/or second smart contracts.

The chain-one-to-channel data transaction is a transaction (i.e. a message) on the first Blockchain platform. “chain-one” refers to the first Blockchain platform, while “channel” refers to the channel. The chain-one-to-channel data transaction provides information to the channel relay server related to a transfer of tokens of the particular cryptocurrency from the first Blockchain platform to the channel, such that it may be provided on the second Blockchain platform. The chain-one-to-channel data transaction is initiated by, or on behalf of, the owner entity. Initiating the chain-one-to-channel data transaction may include generating and/or transmitting the chain-one-to-channel data transaction on the first Blockchain platform. The chain-one-to-channel data transaction may have, as a sender address, an address associated with the owner entity. Alternatively, the chain-one-to-channel data transaction may have, as a sender address, an address of a token smart contract on the first Blockchain platform, the token smart contract designed to manage the cryptocurrency tokens. The management of the cryptocurrency tokens may include, for example, an issuance, assignment and/or reassignment of tokens of the cryptocurrency.

The transaction confirmation information provides information to the second smart contract related to the chain-one-to-channel data transaction, in particular that the chain-one-to-channel data transaction has been submitted on the first Blockchain platform and that it has been confirmed on the first Blockchain platform. The transaction confirmation information may be transmitted in the form of one or more transactions on the second Blockchain platform, in particular one or more transactions directed to the second smart contract.

The transaction confirmation information may comprise a chain-two-confirmation data transaction.

The chain-two-confirmation data transaction is a transaction (i.e. a message) on the second Blockchain platform described herein as the chain-two-confirmation data transaction to distinguish it from other transactions having other purposes. “chain-two” refers to the second Blockchain platform. The chain-two-confirmation data transaction provides information to the channel relay server related to a transfer of tokens of the particular cryptocurrency from the first Blockchain platform to the channel, for providing the tokens on the second Blockchain platform. The chain-two-confirmation data transaction may be initiated by, or on behalf of, the owner entity. Alternatively and/or additionally, the chain-two-confirmation data transaction may be initiated by, or on behalf of, the owner entity may be initiated by the channel relay server. Initiating the chain-two-confirmation data transaction may include generating and/or transmitting the chain-two-confirmation data transaction on the second Blockchain platform. The chain-two-confirmation data transaction may be designed to be linked or associated with the chain-one-to-channel data transaction.

The chain-two-confirmation data transaction may match the chain-one-to-channel data transaction, for example by including a copy, reference and/or digest of at least part of the chain-one-to-channel data transaction.

The chain-one-to-channel data transaction may have, as a sender address, an address associated with the owner entity. Alternatively, the chain-one-to-channel data transaction may have, as a sender address, an address of a token smart contract on the first Blockchain platform, the token smart contract designed to manage the cryptocurrency tokens. The management of the cryptocurrency tokens may include, for example, an issuance, assignment and/or reassignment of tokens of the cryptocurrency.

The transaction confirmation information may comprise at least one of the following: at least part of the chain-one-to-channel data transaction or an identifier of the chain-one-to-channel data transaction.

The transaction confirmation information may comprise a witness data transaction comprising a digital signature of a witness (i.e., a witness entity) and at least one of the following: at least part of the chain-one-to-channel data transaction or an identifier of the chain-one-to-channel data transaction. Optionally, the witness data transaction includes authorization information.

The transaction confirmation information may include, for example, the sequence number of a previous (i.e. the last) transaction of the channel relay server, in particular in relation to the owner entity, included in a checkpoint and optionally a proof of the sequence number of the transaction in the previous checkpoint. The sequence number (or a transaction count, in other words), provides a counter indicative of a number of transactions of the owner entity across the channel. The channel, i.e. the channel relay server, may be configured to maintain a sequence number with respect to the owner entity, in particular a current sequence number.

The chain-one-to-channel transaction may further comprise a sequence number. In one example, the transaction confirmation information may optionally include the sequence number of the chain-one-to-channel transaction and/or optionally a proof (i.e., a digital proof) that the sequence number of the chain-one-to-channel transaction is equal to precedes a sequence number of a previous (in particular, the last) transaction included in a checkpoint.

Additionally or alternatively, the transaction confirmation information may comprise a transaction hash, digest and/or an identifier of the chain-one-to-channel data transaction and may further comprise a proof of inclusion of the transaction hash, the digest and/or the identifier in the checkpoint.

For example, transmitting the transaction confirmation information to the second smart contract on the second Blockchain platform comprises determining, using the processor, whether the chain-one-to-channel data transaction has been included in at least one block of the first Blockchain platform, preferably at least three blocks of the first Blockchain platform, most preferably at least ten blocks of the first Blockchain platform. The transaction confirmation information may be transmitted upon affirmative determination.

In an embodiment, the method includes monitoring, by a plurality of channel relay computers of the channel relay server, the first Blockchain platform for the chain-one-to-channel data transaction. The method comprises establishing, by the plurality of channel relay computers, a consensus as to whether the chain-one-to-channel data transaction has been confirmed. The method comprises transmitting, by at least one of the channel relay computers, the transaction confirmation information to the second smart contract, in case of affirmative confirmation in the form of an affirmative consensus.

The channel relay computers are computers, for example including personal computers and/or server computers. The computers may be communicatively connected and may be distributed geographically.

The method may include exchanging, between the channel replay computers, one or more data messages to establish a consensus (e.g., an agreement) as to whether the chain-one-to-channel data transaction has been confirmed. The method may include transmitting the transaction confirmation information from a processor of the channel relay server, in particular from at least one processor of at least one of the plurality of channel relay computers, to the second smart contract only if the consensus was affirmatively established. The method may include transmitting, by a subset of channel relay computers, a number of witness data transactions to a witness smart contract on the second Blockchain platform. For example, witness smart contract is configured such that, if a defined number and/or a defined proportion of the plurality of channel relay computers submit valid witness data transactions (i.e., it may be considered that consensus is reached), the transaction confirmation information is provided, by the witness smart contract, to the second smart contract. For example, the witness smart contract may call an appropriate function of the second smart contract, which function call includes the transaction confirmation information, and/or provide a data transaction to the second smart contract.

In an embodiment, the plurality of channel relay computers of the channel relay servers are distributed computers, in particular physically distributed in a plurality of locations.

In an embodiment, the method includes updating, using the processor, a total balance using the defined number of tokens as included in the chain-one-to-channel data transaction. The total balance is indicative of a defined number of tokens of the particular cryptocurrency currently associated with the owner entity, for example the total number of tokens currently associated with the owner entity in the first smart contract and/or in the second smart contract. The total balance may be stored (/and/or maintained) in a memory of the channel relay server. Additionally or alternatively, the total balance may be stored on the first Blockchain platform, for example in the first smart contract, and/or on the second Blockchain platform, for example in the second smart contract. The total balance may be stored on a client computer. The total balance may comprise a plurality of partial balances, wherein a first partial balance may represent a net number of tokens transmitted and/or received, on the first Blockchain platform, from the owner entity to the first smart contract (and/or vice-versa), and a second partial balance, wherein the second partial balance may represent a net number of tokens transmitted and/or received, on the second Blockchain platform, by the owner entity using the second smart contract. The first partial balance may be stored on the first Blockchain platform, for example in the first smart contract or computable using data transactions on the first Blockchain platform. The second partial balance may be stored on the second Blockchain platform, for example in the second smart contract. The first and second partial balances may be added together to compute the total balance. The first and/or second partial balances may require confirmation, in particular confirmation of data transactions related to depositing and/or withdrawing tokens to and/or from the respective smart contracts, before being used for computing the total balance.

In an embodiment, transmitting the transaction confirmation information causes the total balance to be updated. In particular, the method comprises updating, using the processor, in a memory of the channel relay server, the current total balance indicative of a number of tokens associated with the owner entity, using a previously stored total balance and the defined number of tokens.

For example, upon transmission of the transaction confirmation information, the channel relay server updates the total balance, in particular the total balance stored in the channel, for example in the memory of the channel relay server.

For example, the transaction confirmation information is designed such that second smart contract updates the total balance (or a partial balance, respectively) associated with the owner entity. In particular the transaction confirmation information may be designed such that second smart contract updates the total balance of the owner entity in an internal register of the second smart contract, which internal register associates the owner entity with the total balance (or a partial balance, respectively). The transaction confirmation information includes, for example, the defined number of tokens and/or a current (i.e. updated) total balance of the owner entity.

In an embodiment, the method further comprises monitoring, using the processor, the first Blockchain platform for a channel-to-chain-one data transaction comprising: the defined target address of the first smart contract, and a third digital signature, wherein the first address of the owner entity is either derivable from the third digital signature, or derivable from the transaction instructions of the channel-to-chain-one data transaction, wherein a second address on the second Blockchain platform is derivable from the execution of the channel-to-chain-one data transaction. The method comprises identifying, using the processor, either: data transactions on the first Blockchain platform, including at least all data transactions since a last confirmed recall of a previous channel-to-chain-one data transaction, the previous channel-to-chain-one data transaction related to both of: the first address and the first smart contract, the data transactions comprising confirmed data transactions and/or unconfirmed data transactions, each data transaction relating to a cryptocurrency token transfer and having a timestamp; and/or a precalculated transaction summary of the aforementioned data transactions. The method comprises identifying, using the processor, either: data transactions on the second Blockchain platform, including at least all data transactions since the last confirmed recall of the previous channel-to-chain-one data transaction, the previous channel-to-chain-one data transaction being related to both of: the second address and the second smart contract, the data transactions comprising confirmed data transactions and/or unconfirmed data transactions, each data transaction relating to a cryptocurrency token transfer and having a timestamp; or comprises identifying a pre-calculated transaction summary of the aforementioned data transactions. The method comprises determining a current total balance of the owner entity using the identified data transactions on the first Blockchain platform (or the pre-calculated transaction summaries of the data transactions on the first Blockchain platform), and the identified data transactions on the second Blockchain platform (or the pre-calculated transaction summaries of the data transactions on the second Blockchain platform). The method comprises transmitting, using the processor, recall rejection information to the first smart contract if the current total balance is negative. The method optionally comprises transmitting, using the processor, recall confirmation information to the first smart contract if the current total balance is non-negative.

The channel-to-chain-one data transaction is a transaction on the first Blockchain platform. The transaction is referred to as a channel-to-chain-one data transaction to better distinguish it from other transactions described herein. The channel-to-chain-one data transaction is generated by, or on behalf of, the owner entity, for example by the client computer of the owner entity or by an RPC server, respectively.

The recall rejection information may be implemented as, or using, a transaction on the first Blockchain platform. The transaction is referred to as recall rejection information to better distinguish it from other transactions described herein. The recall rejection information may be included in, or referenced by, the transaction on the first Blockchain platform. The recall rejection information is directed to or otherwise provided to the first smart contract. The transaction is initiated by, or on behalf of, the channel relay server.

In an embodiment, the channel-to-chain-one data transaction further comprises a defined amount of cryptocurrency tokens to be returned to the first address of the owner entity. Additionally, or alternatively, the channel-to-chain-one data transaction can further comprise an amount of cryptocurrency tokens defining the remaining total balance of the defined type of cryptocurrency token should the recall be confirmed.

In an embodiment, the method comprises implementing, by the computerized channel relay server, using the processor, a node of the first Blockchain platform. Monitoring the first Blockchain platform comprises identifying, using the processor, the chain-one-to-channel data transaction in one or more of the following: in a transaction pool related to the first Blockchain platform and/or in a block of the first Blockchain platform.

In an embodiment, the computerized channel relay server comprises a plurality of channel relay computers, and a subset of the channel relay computers designated as witnesses of the chain-one-to-channel data transaction. The method further comprises submitting, using the processor of a particular one of the channel relay computers designated as a witness, a witness data transaction to the second Blockchain causing the transmitting of the transaction confirmation information. The witness data transaction includes a digital signature of the witness and at least part of the chain-one-to-channel data transaction, or an identifier thereof, and authorization information.

The authorization information may include information related to witness data transactions. The authorization information may define a stake in relation to the witness data transaction, or a reference to an entry of a staking smart contract related to the witness.

For example, the witness data transaction is transmitted to a particular smart contract on the second Blockchain. The witness data transaction is configured to trigger the particular smart contract on the second Blockchain to transmit the transaction confirmation information.

The particular smart contract may in particular be a smart contract separate from the second smart contract on the second Blockchain platform.

In an embodiment, the method comprises monitoring, by the channel relay computers, the second Blockchain platform for a chain-two-confirmation data transaction matching the chain-one-to-channel data transaction, and establishing, in the channel relay computers, a consensus amongst the channel relay computers as to whether the transaction confirmation information is to be transmitted for the chain-one-to-channel data transaction, dependent on the correct execution of the chain-two-confirmation data transaction on the second Blockchain platform.

The chain-two-confirmation data transaction may be submitted by the owner entity. Thereby, the owner entity is able to trigger the transmission of the transaction confirmation information, provided the chain-two-confirmation data transaction is correctly executed, i.e. is a valid transaction. In particular, the chain-two-confirmation data transaction may be transmitted to the second smart contract on the second Blockchain platform, and correct execution may include the second smart contract accepting and successfully executing the chain-two-confirmation data transaction. The second smart contract may update the channel balance and other information stored in the second smart contract upon the successful execution of the chain-two-confirmation data transaction.

In an embodiment, the method comprises implementing, by the computerized channel relay server, a node of the second Blockchain platform. Monitoring, using the processor, the second Blockchain platform comprises identifying, using the processor, a chain-two-confirmation data transaction in one or more of the following: in a transaction pool related to the second Blockchain platform and/or in a block of the second Blockchain platform.

In an embodiment, transmitting transaction confirmation information to the second smart contract on the second Blockchain platform comprises: determining, using the processor, whether the chain-one-to-channel data transaction has been included in checkpoint information of the first Blockchain platform and/or of the first smart contract, the checkpoint information being related to one or preferably two checkpoints provided by the first Blockchain platform and/or provided by the first smart contract, respectively. The method comprises generating, using the processor, a chain-two confirmation data transaction on the second Blockchain platform, causing the transmission of the transaction confirmation information on the second Blockchain platform, the chain-two-confirmation data transaction comprising at least part of the chain-one-to-channel data transaction, or an identifier thereof, and authorization information.

The authorization information may include information related to the chain-two-confirmation data transaction. The authorization information may include a proof of inclusion of the chain-one-to-channel data transaction in a checkpoint, typically the most recent checkpoint or the second most recent checkpoint.

In an embodiment, the chain-two confirmation data transaction is generated only if the chain-one-to-channel data transaction has been included in checkpoint information of the first Blockchain platform. The chain-two confirmation data transaction may include the checkpoint information.

In an embodiment, the method comprises transmitting, by a particular (first) channel relay computer of the channel relay server, the transaction confirmation information. The method further comprises transmitting, by a further (second) channel relay computer of the channel relay server, in particular a channel relay computer acting for, or designated as, a witness, a witness data transaction. Additionally or alternatively, the further channel relay computer may transmit a chain-two-confirmation data transaction comprising at least part of the chain-one-to-channel data transaction, or an identifier thereof, and authorization information.

The method may comprise the owner entity transmitting an additional chain-two-confirmation data transaction either prior to, or after, the chain-two-confirmation data transaction transmitted by the further channel relay computer. The method may comprise determining, in the second smart contract, whether both chain-two-confirmation data transactions match.

In an embodiment, the method further comprises identifying, on one or more of: the first Blockchain platform or the second Blockchain platform, checkpoint information related to one or more checkpoints of the first Blockchain platform or the second Blockchain platform, a particular checkpoint comprising commitment data of the smart contract(s), the commitment data comprising a state of the smart contract(s) corresponding to a timestamp of the particular checkpoint information. Optionally, the checkpoint information further comprises a reference to a previous checkpoint information. The method comprises confirming, using the processor, the chain-one-to-channel data transaction using the checkpoint information and generating, using the processor, the transaction confirmation information, in case of affirmative confirmation of the chain-one-to-channel data transaction.

In an embodiment, determining whether the chain-one-to-channel data transaction and the chain-two-confirmation data transaction match comprises comparing, using the processor, a first identifier included in the chain-one-to-channel data transaction and a second identifier included in the chain-two-confirmation data transaction. Additionally, or alternatively, in cases where the chain-two-confirmation data transaction includes a part of the chain-one-to-channel data transaction, a first computed digital digest of the chain-one-to-channel data transaction and a second computed digital digest of the chain-two-confirmation data transaction are compared.

In a further embodiment wherein the chain-two-confirmation data transaction comprises part of the chain-one-to-channel data transaction (i.e. a data field in the chain-two-confirmation data transaction has copied therein part of the data of the chain-one-to-channel data transaction which uniquely specifies the chain-one-to-channel data transaction), determining whether the data transactions match includes comparing the part of the chain-two-confirmation data transaction that uniquely specifies the chain-one-to-channel data transaction with the actual chain-one-to-channel data transaction as recorded in the first Blockchain.

In addition to the method for facilitating a secure transfer of digital assets between two Blockchain platforms, the present disclosure further relates to a computer system for facilitating a secure digital asset transfer between two Blockchain platforms, the computer system comprising a processor configured to implement a channel relay server by executing the method disclosed herein.

In an embodiment, the computer system comprises a plurality of distributed channel relay computers communicatively coupled to each other, for example using the Internet. In an embodiment, each channel relay computer comprises a processor configured to monitor the first Blockchain platform for the chain-one-to-channel data transaction addressed to the first smart contract. The processor is configured to exchange one or more data messages with other channel relay computers to establish in the channel relay server a consensus as to whether the chain-one-to-channel data transaction has been confirmed. Additionally or alternatively, the processor may be configured to transmit data to one or more smart contracts on one or more of the Blockchain platforms. The processor is configured to transmit the transaction confirmation information to the second smart contract in case of the consensus being affirmatively established.

In an embodiment, the processor mentioned above is the processor of the channel relay server, in particular the processor(s) of at least one of the channel relay computer(s).

Consensus may be reached by a defined proportion of the channel relay computers transmitting a data transaction, in particular to a witness smart contract on the second Blockchain platform, indicative of an agreement (i.e., that the chain-one-to-channel data transaction is confirmed). To determine if consensus has been reached, the channel relay computer(s) monitor the Blockchain. Once the consensus has been reached, one of the channel relay computers transmits the transaction confirmation information to the second smart contract.

The present disclosure also relates to a computer system, for example configured to implement a channel relay server as described herein. The computer system is configured to implement a channel for managing transactions between a first Blockchain platform and a second Blockchain platform, in particular as described herein. The computer system is configured to include, in a transaction on the second Blockchain platform, a reference to and/or a copy of a transaction on the first Blockchain platform, the transaction associated with an owner entity and including a defined number of tokens of a particular cryptocurrency. The computer system may be configured to update a balance associated with the owner entity, the balance reflecting a total number of tokens of the particular cryptocurrency associated with the owner entity, upon transmission of the transaction on the second Blockchain platform. The computer system may be configured to perform the same steps recited above in the opposite direction, i.e. from the second Blockchain platform to the first Blockchain platform.

The present disclosure also relates to a channel relay server which comprises a plurality of channel relay computers. At least one of the channel relay computers comprises a processor configured to monitor the first Blockchain platform for the chain-one-to-channel data transaction addressed to the first smart contract. Alternatively, the processor may be configured to transmit data, in particular indicative of a vote, to a communication platform, for example, a first smart contract on the first Blockchain platform, or a second smart contract on the second Blockchain platform. Optionally, the processor may transmit data indicative of a vote concerning confirmation, or proof concerning inclusion in a Blockchain platform. The processor is configured to monitor the communication platform to establish in the channel relay server a consensus as to whether the chain-one-to-channel data transaction has been confirmed, in particular using the transmitted data indicative the vote. The processor is configured to transmit transaction confirmation information to the second smart contract in case the consensus is affirmatively established.

In addition to the method for facilitating a secure transfer of digital assets between two Blockchain platforms and a computerized channel relay server for facilitating a secure digital asset transfer between two Blockchain platforms, the present disclosure further relates to a system for facilitating a secure transfer of digital assets between two Blockchain platforms, the system comprising a computerized channel relay server as described herein and a client computer associated with an owner entity, the client computer comprising a processor configured to generate a chain-one-to-channel data transaction on a first Blockchain platform, the chain-one-to-channel data transaction comprising: a defined target address of a first smart contract, a defined number of tokens of a particular cryptocurrency, and a first digital signature, wherein a first address of the owner entity is derivable either from the first digital signature or from transaction instructions of the chain-one-to-channel data transaction. The processor is configured to generate a channel-to-chain-two data transaction on a second Blockchain platform, the channel-to-chain-two data transaction comprising a target address of a second smart contract and a digital signature providing an authorization of the owner entity.

In an embodiment, the processor does not necessarily generate the channel-to-chain-two data transaction.

In an embodiment, the processor of the client computer is configured to generate a chain-two-confirmation data transaction on the second Blockchain platform addressed to the second smart contract, prior to generating the channel-to-chain-two data transaction, the chain-two-confirmation data transaction comprising at least part of the chain-one-to-channel data transaction (or an identifier thereof), and authorization information.

In an embodiment, the processor of the client computer is configured to transmit transaction confirmation information to the second smart contract on the second Blockchain platform. The transaction confirmation information may include, or be in the form of, a chain-two-confirmation data transaction. Additionally or alternatively, the transaction confirmation may comprise a sequence number and a proof of the sequence number in a checkpoint. The sequence number may be a global counter across both the first Blockchain platform and the second Blockchain platform, indicating how many transactions the particular owner entity has submitted to the channel (i.e., the channel relay server).

In an embodiment, the processor of the client computer is configured to generate a channel-to-chain-one data transaction on the first Blockchain platform, the channel-to-chain-one data transaction comprising: the defined target address of the first smart contract and a third digital signature, wherein a first address of the owner entity is derivable from the third digital signature, or derivable from the transaction instructions, or derivable from the transaction instructions of the channel-to-chain-one data transaction.

In an embodiment, the processor of the client computer is configured to generate a chain-two-to-channel data transaction on the second Blockchain platform, the chain-two-to-channel data transaction comprising: the defined target address of the second smart contract, a defined number of tokens of the particular cryptocurrency, and a second digital signature providing an authorization of the owner entity.

In an embodiment, the system further comprises a first smart contract on the first Blockchain platform configured to receive the chain-one-to-channel data transaction from the first address associated with the owner entity. The first smart contract is configured to generate and store, using data contained in the chain-one-to-channel data transaction, the pair of the first address and the second address of the owner entity on the first Blockchain. Additionally, the first smart contract can be configured to receive data transactions from an address associated with the channel relay server.

In an embodiment, the system further comprises a second smart contract on the second Blockchain platform configured to receive the chain-two-confirmation data transaction comprising at least part of the chain-one-to-channel data transaction, or an identifier thereof, and authorization information. Additionally, the second smart contract is configured to generate and store a current balance of cryptocurrency tokens associated with the owner entity on the second Blockchain, using the defined number of tokens of the chain-one-to-channel data transaction.

In addition to the method for facilitating a secure transfer of digital assets between two Blockchain platforms, the present disclosure further relates to a method for securely transferring digital assets between two Blockchain platforms. The method comprises generating, in a processor of a computer, a chain-one-to-channel data transaction on a first Blockchain platform, the chain-one-to-channel data transaction comprising a defined target address of a first smart contract, a defined number of tokens of a particular cryptocurrency, and/or a first digital signature. A first address of an owner entity is derivable either from the first digital signature or from transaction instructions of the chain-one-to-channel data transaction. The method comprises generating, in the processor, a channel-to-chain-two data transaction on a second Blockchain platform, the channel-to-chain-two data transaction comprising a defined target address of a second smart contract and/or a digital signature providing an authorization of the owner entity.

In an embodiment, the channel-to-chain-one data transaction comprises the defined target address of the first smart contract, and a third digital signature, wherein the first address of the owner entity is either derivable from the third digital signature, or derivable from the transaction instructions of the channel-to-chain-one data transaction. A second address on the second Blockchain platform may be derivable from the execution of the channel-to-chain-one data transaction.

In an embodiment, the method further comprises transmitting, using the processor of the client computer, transaction confirmation information in the form of a chain-two-confirmation data transaction on the second Blockchain platform addressed to the second smart contract. The chain-two-confirmation data transaction comprises a sequence number, a proof of the inclusion of the sequence number in a checkpoint, a proof of the inclusion of the chain-one-to-channel data transaction in a checkpoint, and/or a proof of that the chain-one-to-channel data transaction has been transmitted on the first Blockchain platform. The sequence number is a global counter associated with the owner entity and/or at least one of the smart contracts. The checkpoint is preferably a checkpoint on the first Blockchain platform. The proof is preferably a digital proof as described herein.

In an embodiment, the method further comprises the step of generating, in the processor, a channel-to-chain-one data transaction. The channel-to-chain-one data transaction comprises a defined amount of cryptocurrency tokens to be returned to the first address of the owner entity and/or an amount of cryptocurrency tokens defining a remaining total balance of the defined type of cryptocurrency token should the recall be confirmed. The channel-to-chain-one data transaction may include a target address of the first smart contract.

The present invention also relates to a computer, for example a client computer and/or a remote procedural call server, performing the method as described above.

In addition to the method for facilitating a secure transfer of digital assets between two Blockchain platforms, a computerized channel relay server for facilitating a secure digital asset transfer between two Blockchain platforms, and a system for facilitating a secure transfer of digital assets between two Blockchain platforms, the present disclosure further relates to a computer program product comprising computer program code which directs a processor of a computerized channel relay server to perform the method as disclosed herein.

The present disclosure also relates to a computer program product comprising computer program code which directs a processor a computer to perform a method as described herein.

In an embodiment, the computer program product comprises a non-transitory computer readable medium having stored thereon computer program code as described herein.

### BRIEF DESCRIPTION OF THE DRAWINGS

The herein described disclosure will be more fully understood from the detailed description given herein below and the accompanying drawings, which should not be considered limiting to the invention described in the appended claims. The drawings in which:

FIG. 1 shows a block diagram schematically illustrating a channel relay server, two Blockchain platforms, and a client computer,

FIG. 2A shows a block diagram schematically illustrating a first Blockchain platform,

FIG. 2B shows a block diagram schematically illustrating a second Blockchain platform,

FIG. 3 shows a block diagram schematically illustrating a number of channel relay computers forming a distributed channel relay server,

FIG. 4 shows a block diagram schematically illustrating a channel as provided by the channel relay server,

FIG. 5 shows a flow diagram illustrating a number of exemplary steps for facilitating a secure transfer of cryptocurrency between two Blockchain platforms;

FIG. 6 shows a flow diagram illustrating a number of exemplary steps for transmitting transaction confirmation information to the second Blockchain platform,

FIG. 7 shows a flow diagram illustrating a number of exemplary steps for transmitting transaction confirmation instructions to the second Blockchain platform,

FIG. 8 shows a flow diagram illustrating a number of exemplary steps for transmitting recall confirmation information to the first Blockchain platform and

FIG. 9 shows a flow diagram illustrating a number of exemplary steps for updating the channel; and

FIG. 10 shows a flow diagram illustrating a number of exemplary steps for updating the channel.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

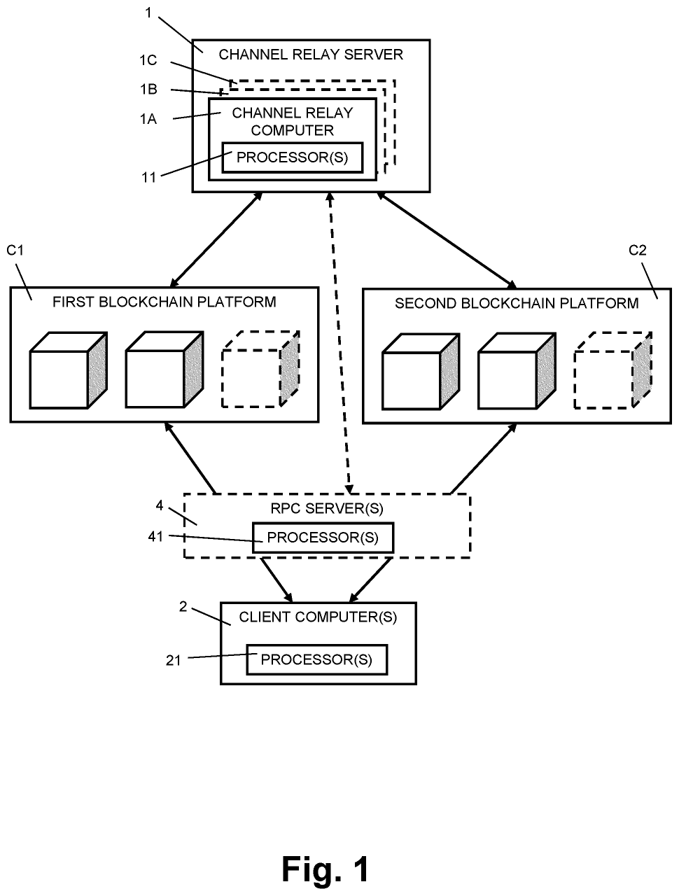

FIG. 1 shows a block diagram illustrating schematically a channel relay server 1, a first Blockchain platform C1 and a second Blockchain platform C2. A channel relay server 1 is a computer system connected to the two Blockchain platforms C1, C2 and configured to interact with the two Blockchain platforms C1, C2. A client computer 2 and optional remote procedural call (RPC) servers 4 are also shown. The channel relay server 1 is connected to the Blockchain platforms C1, C2 via a communication network, for example the Internet. The client computer 2, which comprises at least one processor 21, is similarly connected to the Blockchain platforms C1, C2 via a communication network, for example the Internet. Optionally, the client computer 2 is connected to the Blockchain platforms C1, C2 via one or more RPC servers 4.

The channel relay server 1, as is explained herein in detail, provides functions which enable an owner entity, i.e. a natural and/or legal person, using the client computer 2, to securely transfer cryptocurrency assets, in particular a number of cryptographic tokens, between the first Blockchain platform C1 and the second Blockchain platform C2 in a fast and secure manner which considerably reduces the counterparty risk associated with known methods of transferring cryptocurrency assets using escrows.

The channel relay server 1 comprises one or more channel relay computers 1A, 1B, 1C. The channel relay computers 1A, 1B, 1C are computers, for example comprising personal computers and/or computers in a datacenter. The channel relay computers 1A, 1B, 1C, each have at least one processor 11. The channel relay computers 1A, 1B, 1C can be co-located or distributed across a plurality of locations. The channel relay computers 1A, 1B, 1C can be operated by one or more persons or legal entities, and in an embodiment form a decentralized channel relay server 1.

Depending on the embodiment, the channel relay server 1 is public, such that any computer can freely join the channel relay server 1 as an additional channel relay computer 1A, 1B, 1C. In another embodiment, the channel relay server 1 is permissioned, such that only specific computers may join the channel relay server 1 as a channel relay computer 1A, 1B, 1C.

In an embodiment, the channel relay server 1 performs at least some steps using a consensus mechanism in which the channel relay computers 1A, 1B, 1C agree upon whether a particular step should be performed or not. For example, each channel relay computer 1A, 1B, 1C provides a stake to participate in the channel relay server 1 and, if that channel relay computer 1A, 1B, 1C is deemed to be acting erroneously or maliciously, forfeits the stake. Determining whether a particular channel relay computer 1A, 1B, 1C acts maliciously or not can be based on a consensus mechanism of the channel relay server 1. The consensus mechanism may involve direct communication between the channel relay computers 1A, 1B, 1C. For example, direct communication involves directly exchanging data between the channel relay computers 1A, 1B, 1C. In another example, the consensus mechanism involves the channel relay computers 1A, 1B, 1C interacting with one or more of the Blockchain platforms. In particular, the channel relay computers 1A, 1B, 1C submit data transactions to smart contracts (for example, the witness smart contracts described herein), which smart contracts facilitate the consensus mechanism.

The stake is a defined amount of cryptocurrency tokens which are pledged by an entity, for example by each channel relay computer 1A, 1B, 1C. The pledge is implemented by freezing, locking, and/or receiving and storing, the defined amount of cryptocurrency tokens from the channel relay computer 1A, 1B, 1C. The stake may be unfrozen, unlocked, and/or otherwise returned to the channel relay computer 1A, 1B, 1C upon request or upon particular conditions being met. The stake may, however, also be forfeit or otherwise lost if the channel relay computer 1A, 1B, 1C behaves maliciously, for example by providing transaction confirmation information to an invalid transaction.

The channel relay computers 1A, 1B, 1C, as well as the client computer 2, comprise one or more fixed or mobile computers, including server computers, laptops, desktop computers, or smart phones, and/or other computerized devices, such as tablets or smartwatches etc.

The client computer(s) 2 can be co-located or distributed across a plurality of locations. The client computers 2 can be operated by the owner entity, and in an embodiment form a client computer (2). The steps described as being performed on the client computer(s) 2 do not have to all be performed on the same client computer 2. The owner entity may use one or more client computer(s) 2 to generate the data transactions described herein.

The channel relay server 1, in particular the channel relay computers 1A, 1B, 1C, as well as the client computer 2 and the optional RPC server(s) 4, comprise processor(s) 11, 21, 41 which are configured to perform various steps, as described below in more detail. The processor(s) 11, 21, 41 are configured or programmed, respectively, by computer program code stored in computer-readable memory of the channel relay server 1, the client computer 2, or the RPC server 4, respectively. The computer-readable memory is connected to the processor(s) 11, 21, 41 of the channel relay server 1, the client computer 2, or the RPC server 4, respectively, in a fixed or removable fashion.

The channel relay server 1, the client computer 2, and the RPC server 4 each comprise a communication circuit configured for data communication via the communication network. The communication network comprises the Internet, accessible to the channel relay server 1, the client computer 2, and the RPC server 4 through fixed networks and/or wireless networks. For example, the communication network includes a local area network (LAN), a wireless local area network (WLAN), and/or a mobile radio network, such as a GSM-network (Global System for Mobile communication), a UMTS-network (Universal Mobile Telephone System) or another mobile radio telephone system, for accessing the Internet.

It is clear to the person skilled in the art that the computer program code can comprise compiled and/or uncompiled code and can be packaged into one or more software applications, libraries, or the like. The skilled person is also aware that at least some of the steps can be carried out on other connected devices.

The RPC server(s) 4 are one or more computer servers having a network communication interface that provides remote connection and communication services between the Blockchain platforms C1, C2 and the client computer 2. The RPC server(s) 4 implement a node of one or both of the Blockchain platforms C1, C2. The steps described herein as being performed by the client computer 2, in particular the processor 21 of the client computer 2, may alternatively be carried out, enabled, or supported by the RPC server(s) 4. Specifically, where the client computer 2 does not implement a node of one or both of the Blockchain platforms C1, C2, the RPC servers 4 can be configured to provide an interface to the client computer 2, enabling the client computer 2 to interact with one or both of the Blockchain platforms C1, C2.

For example, the RPC server(s) 4 may provide an application programming interface (API), a web server, and/or any other means for receiving instructions from the client computer 2.

In an example, the client computer 2 may have installed thereon a client software application.

The RPC server(s) and/or client software application may be configured to generate the data transactions for the owner entity as described herein, in particular the chain-two-confirmation data transaction T2 and the channel-to-chain-one data transaction T3.

The Blockchain platforms C1, C2 are decentralized computing platforms, particularly append-only Blockchain platforms, for example, the well-known Bitcoin or Ethereum Blockchains, which comprise a large number of communicatively coupled computing nodes configured to maintain a blockchain consensus mechanism secured canonical sequence of Blocks and reach agreement about subsequent Blocks to be appended to the sequence. The computing nodes can include full nodes that store the complete Blockchain and light nodes which store only a part of the Blockchain of a given Blockchain platform C1, C2.

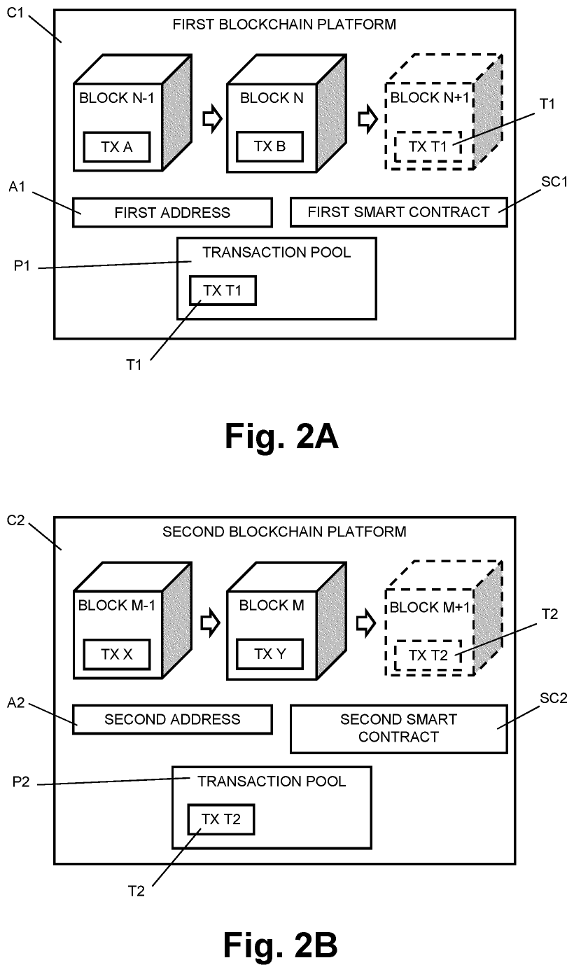

Additional aspects and features of the Blockchain platforms C1, C2 relevant to the present disclosure discussed with reference to FIGS. 2A and 2B below.

In an embodiment, the channel relay server 1 implements a node (e.g. a full node or a light node) of the first Blockchain platform C1 and/or a node (e.g. a full node or a light node) of the second Blockchain platform C2.

FIGS. 2A and 2B show block diagrams illustrating schematically the first Blockchain platform C1 and the second Blockchain platform C2, respectively. Each Blockchain platform C1, C2 comprises a sequence or list of blocks as illustrated. The sequence is established using a consensus mechanism by the Blockchain platform C1, C2. Each block comprises a number of data transactions TX. Each data transaction TX indicates and comprises the amounts of a crypto currency asset, e.g. Bitcoin or Ether, transferred, for example, from a sender, the sending entity, to a recipient, the receiving entity. The sender is identified by a sender address and the recipient is defined by a target address. For example, in Ethereum, the transaction entities are accounts defined by a twenty-byte address. For example, the address of a digital wallet identifies a cryptographically linked key pair (consisting of the public key and a private key, usually by deriving from the public key, however it may not be able to derive the public key from the address). In addition to amounts of a cryptocurrency asset, the data transactions can optionally comprise additional data. As shown in FIG. 2A, Block N−1 comprises a data transaction TX A and Block N comprises a data transaction TX B. A currently proposed Block N+1 comprises a data transaction TX T1. As shown in FIG. 2B, Block M−1 comprises a data transaction TX X and Block M comprises a data transaction TX Y. A currently proposed block M+1 comprises a data transaction TX T2.

In this disclosure, the sender addresses A1, A2, on one or both of the Blockchain platforms C1, C2 respectively, belongs to, for example, an owner entity, which may be a natural or legal person, or a collection of natural and/or legal persons. Additionally, the sender address A2 on the second Blockchain platform C2 belongs to a separate owner entity.

A system including the smart contracts SC1, SC2, and including the channel relay server 1, acts as or implements a channel between the Blockchain platforms C1, C2, either for the owner entity or for the owner entity and the separate owner entity. The channel is described in more detail with reference to FIG. 4. A cryptocurrency total balance associated with the owner entity and stored in the channel can be freely withdrawn by the owner entity and/or the separate owner entity. Without loss of generality, throughout this disclosure, we can assume that the channel belongs to a single owner entity, and that the separate owner entity is the same as the owner entity. In this case, the sender addresses A1, A2, of the owner entity, can be instructed by one or more digital wallets, on one or both of the Blockchain platforms C1, C2. These digital wallets are identified by their signer addresses, and transactions from these digital wallets are authorized by using the (secretly kept) private key matching their public key (by which the address is derived from) to digitally sign a transaction. As such, the transactions comprise a digital signature. Using the digital signature, third parties can confirm firstly the signer of the transaction, and also that the transaction was transmitted from the signer wallet and authorized by the signer, i.e. that the private key belonging to the signer digitally signed the transaction. In an example, when the sender address A1 of the owner entity is identified and directly instructed by a digital wallet, the sender address A1 can be derived from the digital signature. In another example, the owner entity may employ mechanism such as multi-signature wallets or smart contracts, where it is configured to permit a transaction in the name of the sender address A1, if and only if a predefined number of signatures from a list of authorized signer wallets provide their digital signatures for the instruction to be executed. In this case, third parties can confirm the signer of the transactions, and also that the data transaction(s) was authorized by the signers. Further, the multi-signature mechanism, using additional functions of the Blockchain platforms C1, C2 and/or smart contracts on these Blockchain platforms, when successfully authorized, allows the signed instructions to be executed on the Blockchain platforms C1, C2 in the name of the sender address A1 of the owner entity.

There is a total balance of cryptocurrency tokens associated with the channel (i.e., the channel relay server 1) which may be stored in, recorded by, and/or determined by the channel (e.g., stored on a memory of the channel relay server). This total balance may be referred to as the channel balance. The total balance is associated with the owner entity. The total balance may be computed, determined and/or reconciled based on the data transactions on the first and second Blockchain platforms C1, C2, as well as optionally the data transactions in the transaction pool of the first and second Blockchain platforms C1, C2. At least one of: the channel relay server 1 or the client computer 2 may be configured to compute, maintain, reconcile and/or update the total balance, and optionally to store further information related to the channel in their respective memories. The total balance may include a freely withdrawable portion of the total balance, and/or a locked portion of the total balance.

In an example, the further information related to the channel comprises one or more of the following: a sequence number associated with the channel, a freely withdrawable part of the total balance to the first Blockchain platform C1 a respectively freely withdrawable part of the total balance of the second Blockchain platform C2, a list and/or a summary of cryptocurrency tokens in the process of being deposited into the channel or withdrawn from the channel on the first Blockchain platform C1, or a list and/or a summary of cryptocurrency tokens in the process of being deposited into the channel or withdrawn from the channel on the second Blockchain platform C2. The cryptocurrency tokens in the process of being deposited into the channel or withdrawn from the channel are not yet confirmed by the channel (i.e., the channel relay server) and therefore are not considered when calculating and/or updating the total balance of the channel. Only once the transaction with which the cryptocurrency tokens is associated has actually been confirmed by the channel can the total balance reflect this transaction.

For example, a transaction in the process of being deposited into the channel on the first Blockchain platform C1 may include the transaction not yet having been confirmed by the channel, for which a transaction confirmation information has not yet been provided by the channel relay server. In other words, the cryptocurrency tokens are not yet able to be transferred to the first and/or second Blockchain platforms.

The cryptocurrency tokens in the process of being withdrawn from the channel to the first Blockchain platform C1 may be understood as tokens in the channel for which a recall has not yet been confirmed (e.g., neither recall rejection information nor recall confirmation information has been received on the first Blockchain platform C1).

The list or summary of the cryptocurrency tokens in the process of being deposited into and/or withdrawn from the channel is also known as the pending transfer information.

In addition to transactions addressed to one or more digital wallets on a particular Blockchain C1, C2, a transaction can also be addressed to a smart contract, and/or if allowed by the specific Blockchain platform C1, C2, addressed to a combination of one or more smart contracts and digital wallets.

A smart contract is a computer program stored on a Blockchain platform C1, C2, which is executed on by the Blockchain platform C1, C2 when predetermined conditions are met, in particular when a transaction is addressed to the smart contract. The smart contract comprises one or more functions and a data store. When a smart contract receives a transaction directed to it, it can perform one or more functions according to the transaction and according the data store of the smart contract. The smart contract can, depending on the functions, call one or more functions of, as well as transfer cryptocurrency to, another smart contract(s) (or function(s) thereof) or transfer cryptocurrency to one or more addresses.

As well as their native cryptocurrencies, the Blockchain platforms C1, C2, also support non-native cryptocurrencies, which are additional classes of assets on these Blockchain platforms C1, C2. For example, cryptocurrencies according to the ERC-20 standard have proven to be popular on the Ethereum platform. Another example is USDT according to OmniLayer on the Bitcoin platform. Other examples include wrapped Bitcoin (WBTC), which allows for the exchange of a cryptocurrency pegged in value to Bitcoin on other Blockchain platforms, for example Ethereum.

There are cases where a particular cryptocurrency is available on multiple Blockchain platforms, in particular on the first Blockchain platform C1 and on the second Blockchain platform C2. In these cases, the owner entity has a first address A1 on the first Blockchain platform C1 and a second address A2 on the second Blockchain platform C2, each having a particular amount of the particular cryptocurrency available. The cryptocurrency is either stored directly linked to the addresses A1, A2, or managed by smart contracts, in which the internal data store of the smart contracts defines a current balance of the owner entity.

The first Blockchain platform C1 comprises, according to this disclosure, a first smart contract SC1 configured to perform a particular set of steps and to store a particular set of data as described herein. It is configured specifically to operate in conjunction with the channel relay server 1 to perform one or more of the steps as described herein.

Analogously, the second Blockchain platform C2 comprises, according to this disclosure, a second smart contract SC2 configured to perform a particular set of steps and to store a particular set of data as described herein. It is configured specifically to operate in conjunction with the channel relay server 1 to perform one or more of the steps as described herein.

In an embodiment, the first smart contract SC1 on the first Blockchain platform C1, and/or the second smart contract SC2 on the second Blockchain platform C2, are each configured to store and/or maintain information related to a plurality of channels, wherein the channel relay server 1 may be configured to implement and/or otherwise provide a separate channel for each of a plurality of owner entities. The information may include, for example, some of the following information for each channel: an address of the owner entity on the first Blockchain platform C1, an address of the owner entity on the second Blockchain platform C2, a sequence number of the last executed transaction on the first Blockchain platform C1, a sequence number of the last executed transaction on the second Blockchain platform C2, a sequence number of the last executed transaction which resulted in a successful withdrawal of a cryptocurrency tokens from the channel to an address on the first Blockchain platform C1, a sequence number of the last executed transaction which resulted in a successful withdrawal of cryptocurrency tokens from the channel into an address on the second Blockchain platform C2, the total balance and related information for a particular sequence number, a freely withdrawable part of the total balance to an address on the first Blockchain platform C1, a freely withdrawable part of the total balance to an address on the second Blockchain platform C2, a list or a summary of cryptocurrency tokens in the process of being deposited into and/or withdrawn from the channel on the first Blockchain platform C1, or a list or a summary of cryptocurrency tokens in the process of being deposited into and/or withdrawn from the channel on the second Blockchain platform C2. The list or summary of the cryptocurrency tokens in the process of being deposited into and/or withdrawn from the channel is also known as the pending transfer information.

Additionally, the Blockchain platforms C1, C2 each comprise a transaction pool P1, P2. The transaction pools P1, P2, each comprise a currently pending transaction TX T1, TX T2. A pending transaction TX T1, TX T2, is a transaction that has been submitted by a sender or a smart wallet but has not yet been incorporated into a Block. The individual computing nodes of the respective Blockchain platforms C1, C2 may propose a new Block, in particular a proposed Block N+1 and a proposed Block M+1, respectively, which Blocks incorporate the pending transactions TX T1, TX T2, respectively. The mechanism by which the computing nodes of the Blockchain platforms C1, C2 reach a consensus can be proof of work, proof of stake, or the like. The person in the art is aware that, in some circumstances, a fork can occur in which the canonical sequence of Blocks branches and it is unclear which of two accepted Blocks will ultimately be part of the canonical sequence, and that it may take a certain amount of time for the Blockchain platform C1, C2, to re-establish the canonical sequence. Therefore, a recipient of cryptocurrency funds may wait until the transaction containing the given transaction is a few Blocks “deep”, i.e. that a number of subsequent Blocks have been appended to the Blockchain referencing the Block containing the given transaction. Depending on the specific Blockchain, it can take several minutes (for Bitcoin approximately ten minutes) for a new Block to be added, and therefore if the recipient wishes to wait until the Block containing the given transaction is three Blocks deep, for example, they would be required to wait approximately thirty minutes until they are of a reasonably high certainty that the transaction will not be rescinded caused by, for example, a fork in the Blockchain.

A data transaction on the first Blockchain platform C1 or the second Blockchain platform C2 may be configured to invoke one or more further data transactions which interact directly or indirectly with the channel, the first smart contract SC1, and/or the second smart contract SC2. The interactions of certain types of data transactions with the channel, the first smart contract SC1 and/or the second smart contract SC2 are described below, in particular for the case that the data transaction is valid and its instructions are successfully executed on or by its respective Blockchain platform C1, C2 and/or respective smart contract SC1, SC2, for example. The method to determine whether a data transaction is valid includes but is not limited to checking the sequence number against the global counter associated with the channel, validating the signature of the transaction against the owner entity, checking the format and any other data of the data transaction and its instructions, checking whether the transaction meets any defined preconditions to be executed, such as a previous matching data transaction, consensus being reached or not, expiration time and/or conditions defined in a smart contract. The same data transaction may be transmitted to both the first smart contract SC1 on the first Blockchain platform C1 and the second smart contract SC2 on the second Blockchain platform C2.

The transmitting of the copy of a data transaction, i.e. an identical data transaction, may be performed by an entity different (e.g. a different computer) from the entity which submitted the first instance of the data transaction. For example, the data transaction on the second Blockchain platform C2 may be transmitted by the owner entity, while an identical data transaction on the first Blockchain platform C1 may be transmitted by the channel relay server 1.

As described herein, information associated with the owner entity and/or the channel may be stored. This information may be stored, for example, in the computer memory of the channel relay server 1, the client computer 2, the RPC server 4, the first smart contract SC1 on the first Blockchain platform C1 and/or the second smart contract SC2 on the second Blockchain platform C2. Specifically, the information may be distributed between one or more of the aforementioned.

The execution of data transactions may cause an update or change in the information stored. In particular, the data transaction may be configured to cause an update, and/or include information which is used, by the one or more devices and/or entities described herein, to update or change the stored information. Which device and/or entity updates information may further depend on where the information is stored and/or where the data transaction is executed. For example, the execution of a data transaction on the first Blockchain platform may cause an update of information in the first smart contract. Similarly, the execution of a data transaction on the second Blockchain platform may cause an update of information in the second smart contract. To avoid any confusion, in an example, the execution of a data transaction on the second Blockchain platform may cause an update of information related to the first Blockchain platform in the second smart contract. The information may be related to transactions from the channel on the first Blockchain platform and/or a state of the first smart contract, the information being transmitted on the second Blockchain platform by the channel relay server. In another example, the execution of a data transaction on the first Blockchain platform may cause an update of information related to the second Blockchain platform in the channel relay server 1, the RPC server 4, and/or the client computer 2.

For example, when a chain-two-to-channel data transaction is valid and successfully executed, the following may occur by appropriate configuring of the data transaction and/or the device and/or entity: increasing the total balance by the defined amount of cryptocurrency tokens (i.e. a credit), increasing the freely withdrawable part of the total balance from the channel to an address on the second Blockchain platform C2 by the defined amount of cryptocurrency tokens, and/or increasing the balance of cryptocurrency tokens stored in the second smart contract SC2 on the second Blockchain platform C2 by the defined amount.

For example, when a channel-to-chain-two data transaction is valid and successfully executed, the following may occur by appropriate configuring of the data transaction and/or the device and/or entity: decreasing the total balance by the defined amount of cryptocurrency tokens; decreasing the freely withdrawable part of the total balance from the channel to an address on the second Blockchain platform C2 by the defined amount of cryptocurrency tokens; and/or decreasing the balance of cryptocurrency tokens stored in the second smart contract SC2 on the second Blockchain platform C2 by the defined amount.

For example, when a channel-to-chain-one data transaction is valid and successfully executed, one or more of the following may occur by appropriate configuring of the data transaction and/or the device and/or entity: locking of the defined amount of cryptocurrency tokens from the total balance; a temporary subtraction of the defined amount of cryptocurrency tokens from the freely withdrawable part of the total balance to an address on the second Blockchain platform C2; the pending transfer information from the channel to defined address(es) on the first Blockchain platform C1 taking place by amending the relevant information of the channel-to-chain-one data transaction.

For example, when the recall confirmation information is valid and successfully executed, the following may occur by appropriate configuring of the recall confirmation information (or the data transaction which comprises the recall confirmation information) and/or the device and/or entity. The defined amount of cryptocurrency tokens of the total balance may be unlocked, the freely withdrawable part of the total balance may be increased, wherein the freely withdrawable part of the total balance is withdrawable, for example, to an address on the first Blockchain platform C1. The defined amount may be reduced from the freely withdrawable part of the total balance or a temporarily subtracted amount of cryptocurrency tokens from the freely withdrawable part of the total balance is reduced, wherein the freely withdrawable part of the total balance may be withdrawable, for example, to an address on the second Blockchain platform C2. The pending transfer information from the channel to one or more defined address(es) on the first Blockchain platform C1 may be maintained, for example by removing and/or updating the relevant information of the channel-to-chain-one data transaction. The sequence number of the last successful channel-to-chain-one data transaction may be updated (e.g., incremented by one) and/or saved. The remaining total balance at the defined sequence number and/or after the defined sequence number may be updated and/or saved.

For example, when the recall rejection information is valid and/or successfully executed, the following the following may occur by appropriate configuring of the recall confirmation information (or the related data transaction which comprises the recall confirmation information) and/or the device and/or entity: the defined amount of cryptocurrency tokens from the total balance is unlocked; the defined amount of cryptocurrency tokens from the freely withdrawable part of the total balance to an address on the second Blockchain platform C2 is unlocked; the pending transfer information from the channel to defined address(es) on the first Blockchain platform C1 is maintained, for example by removing or updating the relevant information of the channel-to-chain-one data transaction.

In an embodiment, in order to withdraw further tokens from the channel, a withdrawal instruction is transmitted on the first Blockchain platform C1, in particular subsequent to or following the channel-to-chain-one data transaction T3. The withdrawal instruction, which may be included in a withdrawal data transaction transmitted on the first Blockchain platform C1, may be addressed to and/or configured to trigger one or more function calls of one or more further smart contracts on the first Blockchain platform C1 (e.g., smart contracts according to the ERC20 standard). The further function calls may comprise instructions to transfer or credit the full or partial amount of cryptocurrency to the owner entity, in particular to an address associated with the owner entity on the first Blockchain platform C1.

The withdrawal instruction may be generated and/or provided by the owner entity, the channel, and/or the smart contract SC1, for example. The transmission of the withdrawal instruction may, in particular, be triggered by one or more of the following: the recall confirmation information being valid and/or executed, a subsequent withdrawal data transaction transmitted by the client computer 2 to the first Blockchain platform C1, or any subsequent data transaction transmitted to the first smart contract SC1 on the first Blockchain platform C1.

The same withdrawal instruction may be optionally transmitted to one or more further smart contracts on the second Blockchain platform C2 for updating information stored related to the freely withdrawable part of the total balance from the channel to an address on the first Blockchain platform C1. The withdrawal instruction may be transmitted by the owner entity and/or by the channel itself (i.e., the channel relay server 1).

For example, the channel relay server 1 may be configured to transmit a balance update data transaction to one or more further smart contracts on the second Blockchain platform C2. The balance update data transaction may include part of the withdrawal instruction, a reference or digest thereof, and/or be associated with the withdrawal instruction in another manner. The balance update data transaction may be implemented as, include at least part of, or associated with, the recall information, in particular the recall confirmation information. The balance update data transaction is configured such that the second smart contract SC2 updates an internal total balance associated with the owner entity according to the withdrawal instruction.

For example, when a further withdrawal instruction following the recall confirmation information of the channel-to-chain-one data transaction is valid and successfully executed, depending on where the data transaction is executed, one or more of the following may occur by appropriate configuring of the data transaction and/or the device and/or entity, in particular using the information defined in the withdrawal instruction and the related channel-to-chain-one data transaction: decreasing the freely withdrawable part of the total balance to an address on the first Blockchain platform C1 by the defined amount, maintaining the pending transfer information from the channel to defined address(es) on the first Blockchain platform C1 by removing and/or updating the relevant information of the channel-to-chain-one data transaction T3, decreasing the balance of cryptocurrency tokens stored in the first smart contract SC1 on the first Blockchain platform C1 by the defined amount, or decreasing the balance of cryptocurrency tokens stored in the first smart contract SC1 on the second Blockchain platform C1 by the defined amount. Depending on the implementation and the type of the cryptocurrency token, optionally decreasing the balance of cryptocurrency tokens stored in the second smart contract SC2 on the second Blockchain platform C2 by the defined amount.

In an embodiment, the transmission of a subsequent transaction following a channel-to-chain-one data transaction T3, prior to any valid matching recall confirmation or recall rejection information being transmitted to the same Blockchain platform and/or being considered valid and/or successfully executed, may cause the channel information to be updated as follows. The channel information may be stored in the computer memory of the channel relay server 1, the client computer 2, the first smart contract SC1 on the first Blockchain platform C1 and/or the second smart contract SC2 on the second Blockchain platform C2. The channel information may be updated using the information defined in the channel-to-chain-one data transaction T3. In a first step, and as a precondition, it is checked whether the predefined time period to provide recall rejection has expired, and if the time period has expired, to optionally execute one or more of the following steps: triggering the generation and/or transmission of recall confirmation information and executing one or more of the instructions of the recall confirmation information as described herein. Additionally, if the data transaction contains a further withdrawal instruction, executing the same instructions as the further withdraw instruction as described above, following the recall confirmation information described before.

In an embodiment, if a chain-one-to-channel data transaction T1 is valid and successfully executed, depending on where the chain-one-to-channel data transaction T1 is executed, the channel information is updated as follows. The channel information may be stored in the computer memory of the channel relay server 1, the client computer 2, the first smart contract SC1 on the first Blockchain platform C1 and/or the second smart contract SC2 on the second Blockchain platform C2. The channel information may be updated and/or maintained using the information defined in the chain-one-to-channel data transaction T1. The pending transfer information from the defined address(es) on the first Blockchain platform C1 to the channel may be maintained by amending the relevant information of the chain-one-to-channel data transaction T1. The balance of cryptocurrency tokens stored in the first smart contract SC1 on the first Blockchain platform C1 may be increased by the defined amount.

In an embodiment, if a transaction confirmation information, a chain-two-confirmation data transaction and/or a witness data transaction is valid and/or successfully executed, depending on where the data transaction is executed, the channel information is updated as follows. The channel information may be stored in the computer memory of the channel relay server 1, the client computer 2, the first smart contract SC1 on the first Blockchain platform C1 and/or the second smart contract SC2 on the second Blockchain platform C2. The channel information may be updated using the information defined in the transaction confirmation information and/or the data transaction and the matching chain-one-to-channel data transaction as follows. The total balance may be increased by the defined amount. The freely withdrawable part of the total balance to an address on the second Blockchain platform C2 may be increased by the defined amount. The pending transfer information from the defined address(es) on the first Blockchain platform C1 to the channel may be maintained by updating or removing the relevant information of the chain-one-to-channel data transaction. The balance of cryptocurrency tokens stored in the first smart contract SC1 on the first Blockchain platform C1 may be increased by the defined amount. Depending on the implementation and the type of the cryptocurrency token, the balance of cryptocurrency tokens stored in the second smart contract SC2 on the second Blockchain platform C2 may optionally be increased by the defined amount.

In an embodiment, a lock instruction is transmitted on the first Blockchain platform and/or the second Blockchain platform. The lock instruction is a transaction on the first Blockchain platform and/or the second Blockchain platform. The lock instruction is transmitted by, or on behalf of, the owner entity, for example by the client computer. The lock instruction has, depending on the Blockchain platform, a target address of the first smart contract or the second smart contract. The lock instruction defines a number of tokens of the cryptocurrency to lock. Locking the tokens is similar to staking in that the tokens are frozen or otherwise prevented from being withdrawn unless certain conditions are met. The lock instruction may include a condition for unlocking (i.e. releasing the stake). The condition may include unlock approval instruction from the DeFi application (i.e., receiving a transaction including the unlock approval instruction on the first Blockchain platform and/or the second Blockchain platform).

The lock instruction may be issued (i.e., provided and/or transmitted) in combination with a channel-to-chain-one data transaction T3. For example, a channel-to-chain-one data transaction T3 enables a particular amount of cryptocurrency tokens to be freely withdrawable to an address on the first Blockchain platform C1, while at the same time a defined amount of cryptocurrency tokens is locked from the freely withdrawable part of the total channel balance to an address on the first Blockchain platform C1, for use in the DeFi application, in particular as a stake or collateral.

In an example, a DeFi application may generate a data transaction including a lock instruction. The data transaction is transmitted or provided to the owner entity (i.e., the client computer 2) for approval (e.g., the owner entity may be required to digitally sign or otherwise authorize the data transaction). The data transaction is then transmitted to the channel, for example on the first and/or second Blockchain platform, by the owner entity (i.e., the client computer 2). Thereby, a collateral is established.

The locked tokens may be used, for example in a cross-chain decentralized finance (DeFi) application in which the locked tokens are taken as collateral for a loan taken out from the DeFi application, for example by the owner entity.

For unlocking or releasing the tokens such that they become available again to the owner entity, an unlock instruction may be transmitted by, or on behalf of, the owner entity and/or the DeFi application to the first and/or second smart contract configured to unlock a defined number of tokens. The unlock instruction is, similar to the lock instruction, also a transaction. The unlock instruction has the effect of unlocking the cryptocurrency (in particular, the stake or a portion thereof) and may be contingent on the condition for unlocking being met.

In one example, the locked portion is associated with a time-lock. The time-lock defines a particular period of time for which the locked portion is not available for unlocking. For example, when the time-lock expires, the unlock instruction of the defined portion of cryptocurrency tokens in the channel may be automatically triggered or explicitly triggered. Thereby, the cryptocurrency tokens are made available.

The lock instructions may be transmitted to both the first Blockchain platform C1 and the second Blockchain platform C2. In other words, a first lock instruction is transmitted to the first Blockchain platform C1 and a second lock instruction is transmitted to the second Blockchain platform C2. This has the effect that the defined number of tokens of the cryptocurrency is simultaneously locked on both the first Blockchain platform C1 and the second Blockchain platform C2.

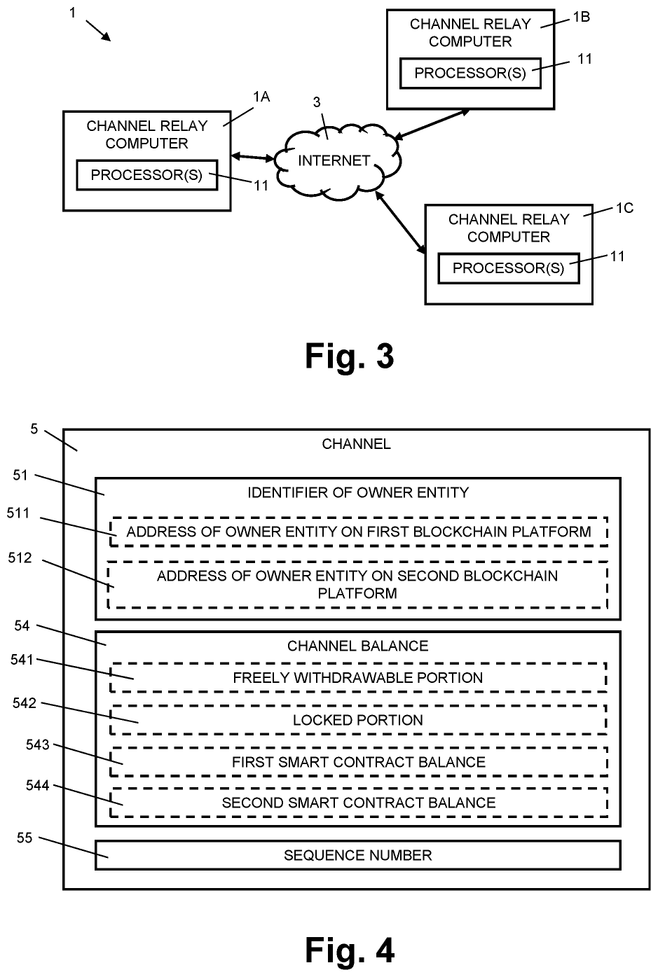

FIG. 3 shows a block diagram illustrating schematically the channel relay server 1 comprising a number of channel relay computers 1A, 1B, 1C communicatively coupled using the Internet 3. As explained herein in more detail, the channel relay server 1 is configured to monitor the first Blockchain C1 and the second Blockchain C2.

In an embodiment, the channel relay server 1 is a decentralized server in which the channel relay computers 1A, 1B, 1C are owned and/or operated by a plurality of entities, and which perform steps as described herein using a consensus mechanism.

FIG. 4 shows a block diagram schematically illustrating a channel 5. The channel 5 is a data object which is designed to store cryptocurrency tokens of the owner entity. Therefore, the channel 5 is configured such that the owner entity may credit tokens of the cryptocurrency to the channel 5 and/or debit tokens from the channel 5. The stored tokens may be used or made available for other protocols running on the first Blockchain platform C1 and/or the second Blockchain platform C2, such as decentralized finance (DeFi) protocols. In particular, a DeFi protocol may make use of the stored cryptocurrency tokens for purposes of establishing a collateral.

For example, the cryptocurrency tokens may be transferred, on the first and/or second Blockchain platform C1, C2, from an address on the first and/or second Blockchain platform C1, C2 associated with the owner entity, to a smart contract SC1, SC2 associated with the channel 5, respectively. The smart contract SC1, SC2 may be configured to update its internal data store to associate an updated total amount of cryptocurrency tokens with the owner entity of the channel 5.

For example, ownership of the cryptocurrency tokens may be transferred, on the first and/or second Blockchain platform C1, C2, from a smart contract SC1, SC2 associated with the channel 5, to an address on the first and/or second Blockchain platform C1, C2 associated with the owner entity. The smart contract SC1, SC2 may be configured to update its internal data store to associate an updated total amount of cryptocurrency tokens with the owner entity of the channel 5.

The channel 5 may further enable a transfer of the cryptocurrency tokens between the Blockchain platforms C1 and C2, in particular from the first Blockchain platform C1 to the second Blockchain platform C2, and/or vice versa.

The channel 5 may be implemented at least in part by the channel relay server 1. The channel 5 may be implemented by two or more entities which interact with each other, for example the channel relay server 1 along with the first and/or second Blockchain platforms C1, C2, in particular the first smart contract SC1 and/or the second smart contract SC2. As such, the data object may be a distributed data object.

The channel relay server 1may use one or more transactions on the first Blockchain and/or second Blockchain for loading information related to the channel, in particular transactions related to the first smart contract SC1 and/or the second smart contract SC2. The channel relay server 1 may further make use of data stored in the smart contracts SC1, SC2. The channel relay server 1, for example, may load data stored in the internal register of the smart contracts SC1, SC2 for loading, updating or maintaining the channel. The channel relay server 1 may further scan the transaction pool on the first Blockchain platform and/or the second Blockchain platform. Further, the sequence number, in particular the current sequence number, may be loaded and/or read from one or both of the smart contracts SC1, SC2.

The channel 5 may be stored at least partly in the memory of the channel relay server 1, in particular in one or more memories of the channel relay computers 1A, 1B, 1C. The channel 5 may be stored at least partly on the first and/or second Blockchain platforms C1, C2, in particular in a data store of the first and/or second smart contracts SC1, SC2.

The channel 5 is designed to implemented, maintain, and update as necessary, information related to the cryptocurrency tokens belonging to the owner entity, in particular cryptocurrency tokens which have been transferred to the channel 5, for example for storing and/or transferring the cryptocurrency tokens from the first Blockchain platform C1 to the second Blockchain platform C2, or vice versa.

The channel 5 may be designed for a single type of cryptocurrency token. The channel 5 may alternatively be designed for a plurality of types of cryptocurrency tokens. The channel 5 is designed for a single owner entity. Multiple channels 5 may be implemented for multiple owner entities, respectively, such that each owner entity has a uniquely assigned channel 5.

The channel 5 includes an identifier 51 of the owner entity. The identifier 51 may include an account number of the owner entity, a name, a telephone number, and/or an official identification number of the owner entity. The identified 51 may include an address of the owner entity on the first Blockchain platform 511. The identifier may include an address of the owner entity on the second Blockchain platform 512.

The channel 5 includes a total balance 54. The total balance indicates a current balance of the owner entity, in particular a current number of cryptocurrency tokens of a particular type of cryptocurrency tokens belonging to the owner entity. The channel 5 may be configured to manage a plurality of types of cryptocurrencies. The total balance 54 may be specific to a particular type of cryptocurrency. The channel 5 may therefore including a plurality of total balances, each related to a specific type of cryptocurrency. The total balance 54 may include a freely withdrawable portion 541, i.e. a specific number of cryptocurrency tokens which the owner entity may be able to immediately withdraw from the channel 5. The freely withdrawable portion 541 may include a freely withdrawable portion to the first Blockchain platform and/or a freely withdrawable portion to the second Blockchain platform. The freely withdrawable portion to the first Blockchain platform may correspond to the token amount associated with the channel-to-chain-one transaction T3. The freely withdrawable portion to the second Blockchain platform may correspond to entire channel balance, however, it may deduct amounts related to pending transactions, for example as associated with the chain-one-to-channel data transaction T1 and/or the channel-to-chain-one transaction T3.

The total balance 54 may include a locked portion 542, i.e. a specific number of cryptocurrency tokens which are currently not available for immediate withdrawal. The locked portion 542 may have associated with it a time-lock, i.e. a particular time period or end-time after which the locked portion 542 becomes available for withdrawal. There may be several locked portions 542, each with a different time-lock. The locked portion 542 may have associated with it a condition to unlock, for example if an approval is authorized from a defined approver, There may be several locked portions 542, each with a different condition to unlock.

The total balance 54 may include a first partial balance 543. The first partial balance is associated with the first Blockchain platform C1, in particular the first smart contract SC1. The total balance 54 may include a second partial balance 544. The second partial balance is associated with the second Blockchain platform C2, in particular the second smart contract SC2. The first and second partial balances 543, 544 may, in sum, yield the total balance 54. The first and/or second partial balances may require confirmation, in particular confirmation of data transactions related to depositing and/or withdrawing tokens to and/or from the respective smart contracts, before being used for computing the total balance 54.

The channel 5 may further include a sequence number. The sequence number is designed such that the channel 5 can validate an incoming or pending transaction. Each validated transaction is associated with a unique sequence number. A new transaction may not use a previously used sequence number. For ensuring that no validating or pending transaction is validated which contains or is associated with a previously validated transaction, the channel 5 is configured to record at least one previously used sequence number, in particular the sequence number of the last validated transaction. An incoming or pending transaction is then required to have a defined relationship with the previously used sequence number, for example it must be greater than the previously used sequence number. For example, the sequence number is a counter, in particular an integer counter, which increments every time a transaction to and/or from the channel occurs. For example, the sequence number increments every time the owner entity transfers a particular number of cryptocurrency tokens to the channel 5 and/or withdraws a particular number of cryptocurrency tokens from the channel 5.

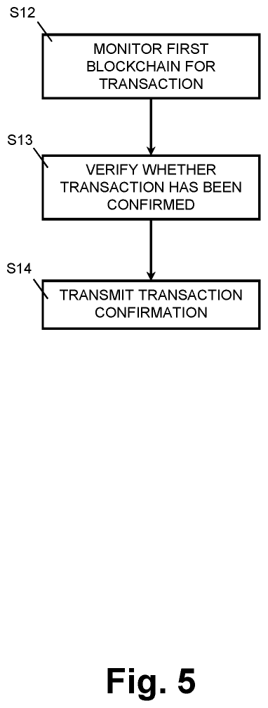

FIG. 5 shows a flow diagram illustrating a number of exemplary steps S12, S13, S14 for facilitating a secure transfer of cryptocurrency between two Blockchain platforms. The steps S12-S14 are performed by a computer system, in particular a server referred to as the channel relay server herein. The computer system may be a distributed system in that it is implemented using a plurality of individual computers, for example the computers referred to as channel relay computers 1A, 1B, 1C herein. The steps S12-S14 may alternatively, or additionally, be performed by another computer, in particular the client computer 2 and/or the RPC server 4.

In the step S12 the first Blockchain platform C1 is monitored for a transaction T1, specifically a transaction T1 described herein as a chain-one-to-channel data transaction T1. The transaction T1 is a transaction on the first Blockchain platform C1 directed to a first smart contract SC1. The first smart contract SC1 is also implemented on the first Blockchain platform C1.

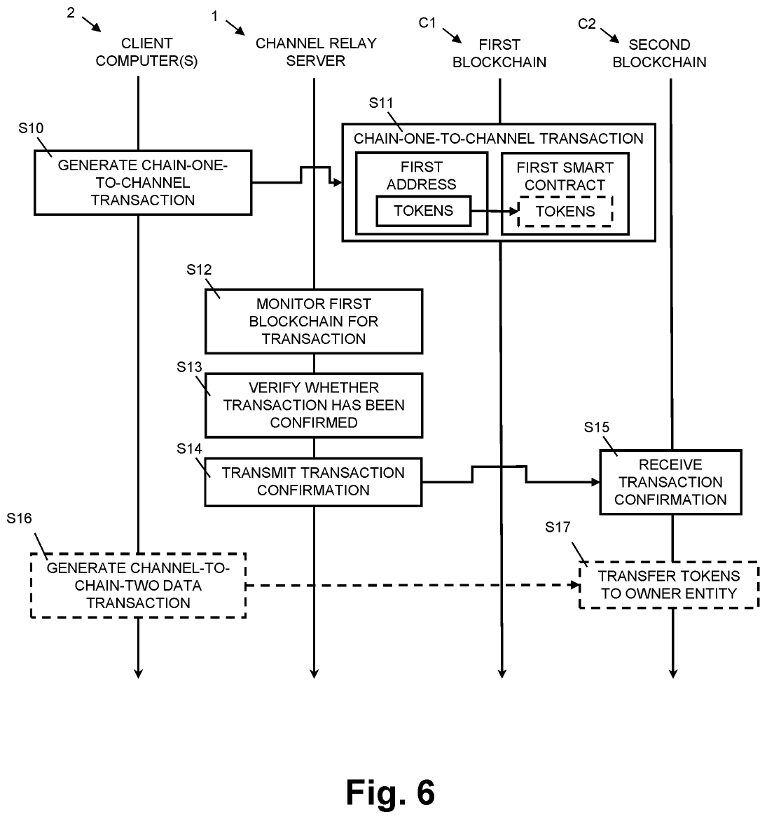

The transaction T1, as described in more detail with reference to FIG. 6 below, originates from an owner entity. Specifically, the transaction T1 may be transmitted by or on behalf of the owner entity and as such includes a first digital signature of the owner entity. The transaction T1 further includes and/or otherwise specifies a defined number of tokens of a particular cryptocurrency, which tokens are intended by the owner entity to be transferred to the second Blockchain platform C2.

For example, the processor(s) 11 of the channel relay computers 1A, 1B, 1C, the processor(s) 21 of the client computer 2 and/or the processor(s) 41 of the RPC server(s) are configured to monitor the first Blockchain platform C1 by identifying whether transactions in the transaction pool P1, in a proposed Block N+1, or in an existing Block call a particular function of the first smart contract SC1 and/or are addressed to the first smart contract SC1. The calling of the particular function of the first smart contract SC1 may be identified by examining a recipient of the transaction T1, by executing the transaction T1, and/or by monitoring events or logs of the execution output.

In an embodiment, the channel relay server 1, in particular the channel relay computers 1A, 1B, 1C, implement a node of the first Blockchain platform C1 and thereby, by receiving transactions and/or Blocks containing transactions from other nodes of the first Blockchain platform C1, monitor the first Blockchain platform C1. Similar considerations apply to the client computer 2 and/or the RPC server(s) 4, which may also implement a node of the first Blockchain platform C1.

In the step S13, it is verified whether the chain-one-to-channel transaction T1 has been confirmed. For example, the processor(s) 11 of the channel relay computers 1A, 1B, 1C verify whether the chain-one-to-channel transaction T1 has been confirmed.

In an embodiment, the chain-one-to-channel transaction T1 is confirmed by identifying whether the chain-one-to-channel transaction T1 is in the transaction pool P1 and/or has been included in at least one Block of the first Blockchain platform C1, preferably at least three blocks of the first Blockchain platform C1, most preferably at least ten blocks of the first Blockchain platform C1. Specifically, what is meant by being included in a defined number of blocks is that the block containing the chain-one-to-channel transaction T1 has been referenced directly or indirectly by at least the defined number of subsequent blocks, such that the block containing the chain-one-to-channel transaction T1 can, to a high degree of certainty, be said to form part of the canonical sequence of blocks of the first Blockchain platform C1. The higher the defined number of subsequent blocks, the higher the degree of certainty that there will not be a fork in the Blockchain and that therefore the transaction cannot be “undone” or reverted.

In an embodiment, the chain-one-to-channel transaction T1 is confirmed by establishing/reaching a consensus. For example, the channel relay server 1 reaches a consensus when a pre-defined number and/or a pre-defined proportion of the channel relay computers 1A, 1B, 1C issue authorizations. In such a manner, the channel relay server 1 can more quickly confirm the chain-one-to-channel transaction T1 than by waiting for the block containing the chain-one-to-channel transaction T1 to be a sufficient number of blocks deep.

In an embodiment, the channel relay computers 1A, 1B, 1C are configured to establish a consensus as to whether the chain-one-to-channel data transaction T1 has been confirmed.

In an embodiment, a first staking smart contract is established on the first Blockchain platform C1 and/or a second staking smart contract is established on the second Blockchain platform C2. Additionally or alternatively, a third staking smart contract is established on a third Blockchain. These staking smart contacts are configured such that the channel relay computers 1A, 1B, 1C can stake cryptocurrency assets as security deposits. The staking smart contracts may further be configured to implement incentive mechanisms such that if the channel relay computers 1A, 1B, 1C act maliciously their stake is forfeited.

Additionally, in an embodiment, the first staking smart contract and/or the second staking smart contract implements a mechanism such that witness data transactions can be submitted to the staking smart contracts. These witness data transactions can speed up particular steps described herein, specifically in association with the transaction confirmation information.

Additionally, in an embodiment, the third staking smart contract implements a mechanism such that witness data transactions can be submitted to the staking smart contracts. These witness data transactions can speed up particular steps described herein, specifically in association with the transaction confirmation information.

For example, by default, after the chain-one-to-channel channel transaction T1 has been submitted to the first Blockchain C1, the owner entity or the channel relay server 1 must submit transaction confirmation information to the second Blockchain C2. This transaction confirmation information confirms that the chain-one-to-channel channel transaction T1 has occurred on the first Blockchain C1. The transaction confirmation information can be validated on the second Blockchain C2 by a smart contract, for example the second smart contract SC2.

Typically, the transaction confirmation information is only transmitted to and/or accepted by the second smart contract SC2 after a checkpoint, the checkpoint confirming the chain-one-to-channel transaction T1. The checkpoint represents a milestone in the first Blockchain C1 and is established at regular intervals, for example ever 100 blocks, or every 4 hours, 8 hours, or once per day. The checkpoint is significant because a double-spending attack becomes extremely difficult and unlikely to occur which reverts or nullifies transactions prior to the checkpoint.

The owner entity may submit the transaction confirmation information to the second Blockchain C2 in the form of a chain-two-confirmation data transaction T2 making use of the checkpoint. Thereby, the data transaction T2 includes a proof of the inclusion of the chain-one-to-channel data transaction T1 on the first Blockchain platform C1 in the data transaction T2. The proof provides evidence of an inclusion of the chain-one-to-channel data transaction T1 on the first Blockchain platform C1, for example that it has been transmitted on the first Blockchain platform C1, in particular included in a checkpoint on the first Blockchain platform C1. The proof is generated by reference the checkpoint and is designed such that it can be validated with reference to the checkpoint. The proof enables others (in particular the recipient) to validate that the chain-one-to-channel data transaction T1 has been included in the checkpoint. Other parties, in particular the channel relay server 1, may also use the proof to validate that the chain-one-to-channel data transaction T1 has been included in the checkpoint.

The proofs described herein are data which are designed to provide evidence of a particular event having occurred or of the existence of particular further data. The proofs are therefore established or configured, by the sender or transmitter of the proof, such that a recipient of the proof may verify the proof. As described herein, the proof may be included in a transaction, for example a transaction on one of the Blockchain platforms.

After the chain-one-to-channel transaction T1 has been confirmed on the first Blockchain platform C1, for example by being incorporated into one or more blocks, the channel relay server 1 may submit the transaction confirmation information in the form of a witness data transaction to the second Blockchain C2, in particular to the second smart contract SC2 or a separate witness smart contract on the second Blockchain C2.

The witness smart contact on the second Blockchain C2 is configured to receive one or more witness data transactions. Depending on the received witness data transactions, the witness smart contract will confirm the chain-one-to-channel transaction T1 by providing transaction confirmation information to the second smart contract SC2, for example by calling an appropriate function in the second smart contract SC2.

For example, the witness smart contract is configured to require a particular proportion of channel relay computers 1A, 1B, 1C to submit a witness data transaction. Additionally, or alternatively, the witness smart contract is configured to require a total staked amount of the channel relay computers 1A, 1B, 1C which submit witness data transactions to meet a defined threshold, the defined threshold, for example, being a value of the tokens of the cryptocurrency in the chain-one-to-channel data transaction T1 transaction or a multiple thereof (e.g., 300%).

This provides information to the second smart contract SC2 regarding the chain-one-to-channel transaction T1, in particular such that the second smart contract SC2 releases the tokens to the owner entity. Thereby, the tokens can be released prior to a checkpoint being reached on the first Blockchain C1, resulting in a quicker release of the funds. However, there is still a risk of double-spending, and the channel relay server 1 (or the channel relay computers 1, respectively) may lose their stake if they provide witness data transactions confirming the channel-one-to-chain data transaction T1 and if a double spending attack occurs and the tokens are lost.

If the chain-one-to-channel transaction T1 has been confirmed, the channel relay server 1, the client computer 2 and/or the RPC server 4, in the step S14, transmits transaction confirmation information to the second smart contract SC2 on the second Blockchain platform C2. This enables the second smart contract SC2 to make the cryptocurrency available to the owner entity on the second Blockchain platform C2, and thereby the channel relay server 1 has facilitated the transfer of the cryptocurrency from the first Blockchain platform C1 to the second Blockchain platform C2. Specifically, the second smart contract SC2 is configured such that it uses the transaction confirmation information to update an internal ledger by crediting the number of tokens to the second address A2 of the owner entity.

Depending on the embodiment, the channel relay server 1, the client computer 2 and/or the RPC server 4 transmits the transaction confirmation information to the second smart contract SC2 by generating a chain-two-confirmation data transaction T2 on the second Blockchain platform C2 or by generating the witness data transaction. The witness data transaction comprises a digital signature of the witness and at least part of the chain-one-to-channel data transaction T1, or an identifier of the chain-one-to-channel data transaction T1, and authorization information. The authorization information can include information related to witness data transactions. More details of the witness data transactions are described herein.

The chain-two-confirmation data transaction T2 is generated using an address on the second Blockchain platform C2 associated with the channel relay server 1, for example. The chain-two-confirmation data transaction T2 is addressed to the second smart contract SC2 and comprises, for example, at least part of the chain-one-to-channel data transaction T1, or an identifier of the chain-one-to-channel data transaction T1. The chain-two-confirmation data transaction T2 further comprises authorization information. The authorization information is data designed such that can include a proof of inclusion of the chain-one-to-channel data transaction T1 in a checkpoint, typically the most recent checkpoint or the second most recent checkpoint. The chain-two-confirmation data transaction is described herein in more detail.

A checkpoint is a data object designed to obtain or improve finality on the Blockchain platform, in the sense that a fork in the Blockchain is unlikely to occur related to any blocks prior to the establishing of the checkpoint. A checkpoint is established on a Blockchain platform, for example, every four hours or every 100 blocks. The checkpoint may be appended to the Blockchain or associated with the Blockchain, in particular in that it may be associated with a particular block. The checkpoint is designed as a reference point from which a state of the Blockchain can be deduced at the point in time that the checkpoint was established. If a double-spend attack on the Blockchain is detected, the Blockchain may omit establishing a checkpoint until the Blockchain is no longer under attack.

In the context of this system, a checkpoint may be established for a subset of Blockchain data related to the channel and the owner entity. For example, the Blockchain data may relate to data of a smart contract. A checkpoint may be based on an implementation of a merkle-tree root hash and/or a cryptographic accumulator. For example, a zero-knowledge proof based system may use a cryptographic accumulator to prove the existence or non-existence of a certain key or key-value pair.

After each checkpoint of the first Blockchain platform C1 is established, checkpoint information is transmitted to a smart contract on the second Blockchain platform C2 by the channel relay server 1, in case of consensus being affirmatively established. For example, a checkpoint information data transaction is transmitted to the second smart contract SC2.

Additionally, after each checkpoint of the second Blockchain platform C2 is established, checkpoint information may be transmitted to a smart contract on the first Blockchain platform C1 by the channel relay server 1, in case of consensus being affirmatively established. For example, a checkpoint information data transaction is transmitted to the first smart contract SC1.

The transaction confirmation information includes, for example, the sequence number of the last transaction of the channel included in a previous checkpoint, and a proof of the sequence number of the last transaction in the previous checkpoint. In another example, the last transaction of the channel included in a previous checkpoint in particular refers to the last transaction of the channel which is transmitted to the first smart contract SC1 on the first Blockchain C1. This enables the second Blockchain C2, in particular the second smart contract SC2, to verify whether the sequence number of the last transaction of the channel included in a previous checkpoint is not smaller than the sequence number of the chain-one-to-channel data transaction T1.

The sequence number in the channel refers to a global counter, for example maintained by the client computer 2 across both the first Blockchain C1 and the second Blockchain C2, indicating, for a particular owner entity, between the pair of the first address A1 on the first Blockchain C1 and the second address A2 on the second Blockchain C2, how many transactions the particular owner entity has submitted to the channel to the first smart contract SC1 and the second smart contract SC2.

In an embodiment, the execution of a data transaction which interacts with the channel by interacting with the first smart contract SC1 on the first Blockchain C1 or the second smart contract SC2 on the second Blockchain C2 causes the sequence number to increase by 1 if the sequence number of the data transaction in relation to the channel and the owner entity matches the next sequence number of the channel.

In an embodiment, the smart contract (i.e., the first smart contract or the second smart contract) checks a data transaction which is addressed to it prior to execution. The smart contract checks the data transaction by inspecting a sequence number included in the data transaction. If the sequence number is not permitted, then the data transaction is not executed and is discarded. The smart contract defines, implicitly or explicitly, a permitted sequence number for the data transaction (in particular, for the current data transaction). The permitted sequence number changes when permitted data transactions are received. The smart contract may store, for example, a last permitted sequence number and may define a rule for determining a next permitted sequence number. The smart contract may, additionally or alternatively, store a permitted sequence number.

For example, if the sequence number included in the data transaction is a duplicate of the sequence number included in another data transaction (in particular a previous data transaction) associated with the channel, then the sequence number is considered not to be permitted and accordingly, the data transaction is not executed and is discarded. Whether the sequence number of the data transaction is a duplicate or not may be determined by comparing it with the current sequence number of the channel (i.e. as stored in or maintained by the channel), the sequence number as included in the last executed transaction of the channel on the first Blockchain platform C1, and/or the sequence number as included in the last executed transaction of the channel on the second Blockchain platform C2. In an example, the sequence number of the data transaction being a duplicate may be determined by identifying another data transaction associated with the channel with the same sequence number, in particular the other data transaction may have already been executed.

In another example, the transaction confirmation information includes a transaction hash of the chain-one-to-channel data transaction T1 and a proof of inclusion of the transaction hash in the checkpoint. Thereby, the second smart contract SC2 can directly confirm the inclusion of the chain-one-to-channel data transaction T1 in the checkpoint.

In another example, the transaction confirmation information includes a digest of part of the chain-one-to-channel data transaction T1 which uniquely identifies of the chain-one-to-channel data transaction T1 and may include a proof of inclusion of the digest in the checkpoint. Alternatively, the transaction confirmation information includes an identifier of the chain-one-to-channel data transaction T1 and a proof of inclusion of the identifier in the checkpoint. The digest, for example, may be a hash, a digital signature or a digital digest of a part of the chain-one-to-channel data transaction T1.

In an embodiment, the chain-two-confirmation data transaction T2 comprises the defined number of tokens of the particular cryptocurrency. The chain-two-confirmation data transaction T2 can further comprise the sender address of the first address A1 of the owner entity. The chain-two-confirmation data transaction T2 can further comprise a recipient address, in particular relating to an address on the second Blockchain platform C2. The address on the second Blockchain platform C2 can also belong to the owner entity, or it can belong to another party.

FIG. 6 shows a flow diagram illustrating a number of steps S10-S17 for transmitting transaction confirmation instructions to the second Blockchain platform C2. Steps S12, S13, S14 are described above with reference to FIG. 5 and are performed by the channel relay server 1. Other steps, in particular S10 and S16 may be performed by or on behalf of the owner entity, for example by the client computer 2 and/or the RPC server. Further steps, such as S11, S15, S17 may be performed by the smart contracts SC1, SC2 on the first Blockchain platform C1 and/or the second Blockchain platform C2.

In the step S10, the client computer 2, associated with the owner entity, submits a chain-one-to-channel data transaction T1 to the first Blockchain platform C1. The client computer 2 submits this transaction itself, in the case that the client computer 2 has implemented a node of the first Blockchain platform C1, or the client computer 2 submits the transaction via the RPC servers 4. The chain-one-to-channel data transaction T1 comprises a defined target address of a first smart contract SC1, a defined number of tokens of a particular cryptocurrency, and a first digital signature, wherein the first address A1 of the owner entity is derivable from the first digital signature, or derivable from the transaction instructions.

The chain-one-to-channel transaction T1 can further comprise a recipient address relating to a second address A2 of the defined number of tokens of the particular cryptocurrency, the second address A2 being on the second Blockchain platform C2.

The chain-one-to-channel transaction T1 can further include a sequence number which may be indicative of a number of transactions which have taken place, in particular between the owner entity and the channel.

In an embodiment, in particular relating to a native cryptocurrency, the chain-one-to-channel transaction T1 is configured to transfer the defined number of tokens of the particular cryptocurrency to the first smart contract SC1 directly, i.e. through the chain-one-to-channel data transaction T1 itself.

In an embodiment, in particular relating to a non-native cryptocurrency, a cryptocurrency smart contract on the first Blockchain is configured to manage the particular non-native cryptocurrency tokens.

The owner entity, the cryptocurrency smart contract, and the first smart contract SC1 can interact to transfer the defined number of cryptocurrency tokens from the owner entity (i.e. the first address A1 of the owner entity on the first Blockchain C1) in a number of ways.

For example, the chain-one-to-channel data transaction T1 is received by the cryptocurrency smart contract that manages the particular cryptocurrency. The cryptocurrency smart contract is configured to process the chain-one-to-channel data transaction T1 and, for example, forward at least part of the chain-one-to-channel data transaction T1 to the first smart contact SC1. Alternatively, or additionally, the cryptocurrency smart contract is configured to update an internal ledger by crediting the particular amount of the cryptocurrency to the first smart contract SC1. Optionally, the cryptocurrency smart contract then calls a function of the first smart contract SC1, or generates an additional data transaction directed to the first smart contract SC1, indicating the credit of the particular amount of cryptocurrency. In another example, the chain-one-to-channel data transaction T1 is specifically configured such that, when the transaction is incorporated into a Block in the first Blockchain C1, the cryptocurrency smart contract is configured to deduct, in the internal data store of the cryptocurrency smart contract, the defined number of tokens from a current balance associated with the sender address, and credit the defined number of tokens to a current balance associated with the first smart contract SC1.

In another example, the cryptocurrency smart contract is configured such that it contains an authorization of the owner entity, authorizing the first smart contract SC1 to interact with the cryptocurrency smart contract on behalf of the owner entity, such that in the execution of the chain-one-to-channel data transaction T1, which is configured to initiate the transfer within the first smart contract SC1, the defined number of cryptocurrency tokens are transferred, in the cryptocurrency smart contract, from the first address A1 of the owner entity to the address of the first smart contract SC1.

In the step S11, the chain-one-to-channel data transaction T1 is received in the first Blockchain platform C1. In particular, the chain-one-to-channel data transaction T1 is received in a transaction pool P1 of the first Blockchain platform C1 and may be incorporated into a pending Block N+1.

In the step S15, the transaction confirmation information is received on the second Blockchain platform C2, specifically it is received in the second smart contract SC2. The second smart contract SC2 is configured such that, using the transaction confirmation information, the defined number of tokens of the particular cryptocurrency are made available to the owner entity or, in an embodiment, to another intended receiver defined by a receiving address. The defined number of tokens of the particular cryptocurrency can be made available to the owner entity. For example, by updating a ledger in an internal data store of the second smart contract SC2 to reflect the deposited defined number of tokens, in particular by crediting the defined number of tokens to the address A2 of the owner entity.

In an embodiment, the channel balance and/or the channel information may be updated, in particular in the memory of the channel relay server and/or in the memory of the client computer. The channel information relates to, for example, the sequence number, pending transfer information, and/or a freely withdrawable part of the total balance.

Depending on the embodiment, the second smart contract SC2 may call one or more functions or make one or more transfers on the second Blockchain platform C2 to one or more further smart contracts and/or addresses.

In a subsequent optional step S16, the client computer 2 is configured to submit a channel-to-chain-two data transaction T4 to the second Blockchain platform C2, the channel-to-chain-two data transaction T4 comprising: a function call to the second smart contract SC2, optionally an address of the owner entity, and a second digital signature of the owner entity. Additionally, the channel-to-chain-two data transaction T4 specifies a defined number of cryptocurrency tokens to be transferred from the second smart contract SC2 to the owner entity. In this manner, the owner entity can withdraw the cryptocurrency from the second smart contract SC2. The client computer 2 submits this transaction itself, in the case that the client computer 2 has implemented a node of the second Blockchain platform C2, or the client computer 2 submits the transaction via the RPC servers 4.

The channel-to-chain-two data transaction T4 is a transaction on the second Blockchain platform C2. The transaction T4 is referred to as a channel-to-chain-two data transaction T4 to better distinguish it from other transactions, in particular the transactions T1, T2, T3 described herein.

In an optional step S17, the second smart contract SC2 transfers the defined number of cryptocurrency tokens, as specified in the channel-to-chain-two data transaction T4 to the owner entity. The transfer of the cryptocurrency tokens can take place in a number of ways as described herein.

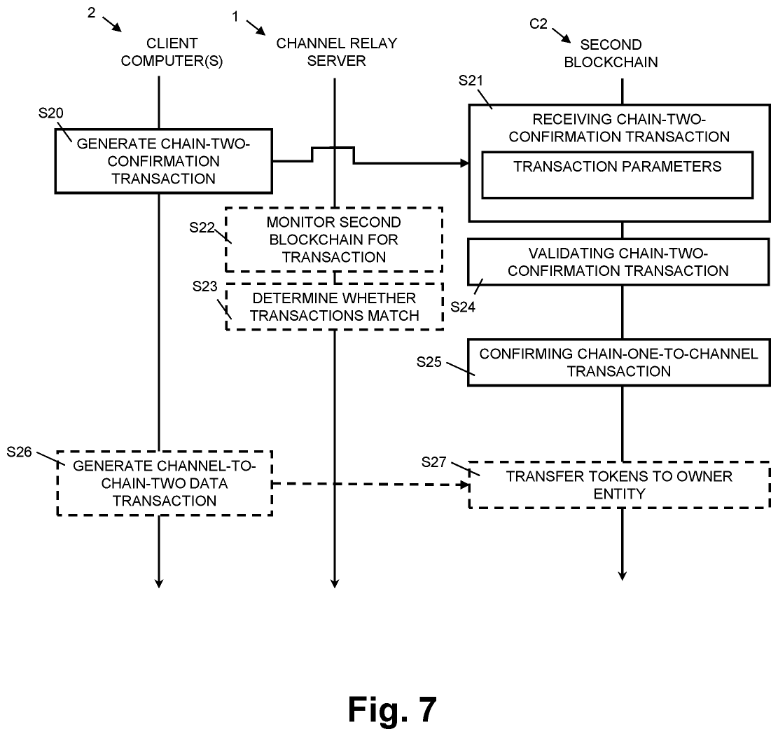

FIG. 7 shows a flow diagram illustrating a number of exemplary steps S20-S27 for transmitting transaction confirmation instructions to the second Blockchain platform C2. These steps apply in cases where the owner entity submits the chain-two-confirmation transaction to the second Blockchain platform C2, instead of or in addition to the channel relay server 1 performing this step.

These steps may be carried out subsequent to step S10 described above with reference to FIG. 6, in which the client computer 2 generates the chain-one-to-channel transaction S10. In the embodiments described with reference to FIG. 7, the client computer 2 generates the chain-two-confirmation data transaction T2 on the second Blockchain platform C2 rather than, or in addition to, the channel relay server 1.

In the step S20, the client computer 2 generates a chain-two-confirmation transaction T2 and submits the chain-two-confirmation transaction T2 to the second Blockchain platform C2. The chain-two-confirmation transaction T2 is a transaction on the second Blockchain platform C2 designated and/or described herein as the chain-two-confirmation transaction T2 in order to better distinguish it from other transactions. Depending on the implementation, this step can involve the RPC server(s) 4, in particular in that the RPC server(s) 4 receive instructions from the client computer 2 to generate and submit the chain-two-confirmation transaction T2. The chain-two-confirmation transaction T2 comprises at least part of the chain-one-to-channel data transaction T1 or an identifier of the chain-one-to-channel data transaction T1.

In an embodiment, the chain-two-confirmation transaction T2 comprises an algorithmic proof referencing checkpoint information of the first Blockchain platform C1, the chain-two-confirmation transaction T2 configured to prove that the owner entity has transferred the defined number of tokens of the cryptocurrency to the first smart contract SC1.

In a step S21, the second Blockchain platform C2 receives the chain-two-confirmation transaction T2. The chain-two-confirmation transaction T2 is received in the transaction pool P2 and may be incorporated into a block of the second Blockchain platform C2.

In an optional step S22, the channel relay server 1 monitors the second Blockchain platform C2, in particular the transaction pool P2 and/or the blocks of the Blockchain, for the chain-two-confirmation transaction T2.

In an optional step S23, the channel relay server 1 determines whether the chain-two-confirmation transaction T2 matches the chain-one-to-channel data transaction T1. In particular, the processor(s) 11 of at least one of the channel relay computers 1A, 1B, 1C is configured to determine whether a match exists. Determining whether the data transactions T1, T2 match may comprise identifying whether at least part of both of the transactions T1, T2 correspond to each other, for example the sender address, a digital signature, and/or an identifier.

In a step S24, the second smart contract SC2 validates the chain-two-confirmation data transaction T2, by comparing whether the referenced checkpoint data included in the chain-two-confirmation transaction T2 matches checkpoint data of the first Blockchain platform C1 which is previously submitted to the second Blockchain platform C2, and by running the algorithmic proof over the proof included in the chain-two-confirmation data transaction T2, to verify whether the proof confirms the inclusion of the chain-one-to-channel transaction T1 using the referenced checkpoint data.

In a step S25, the second Blockchain platform C2 receives the transaction confirmation information, confirming the chain-one-to-channel transaction T1, as described above with reference to step S15.

S26 and S27 are analogous to steps S16 and S17 described above with reference to FIG. 5.

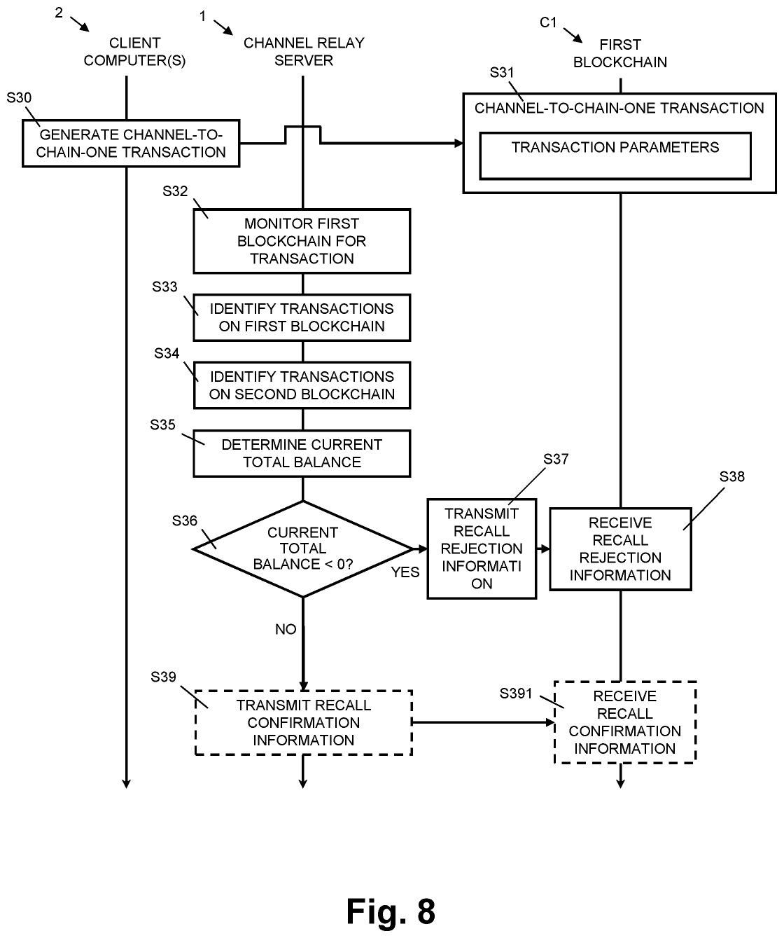

FIG. 8 shows a flow diagram illustrating a number of exemplary steps for transmitting recall rejection/confirmation information to the first Blockchain platform C1. These steps relate to how the owner entity can withdraw cryptocurrency from the channel back to their first address A1 on the first Blockchain platform C1, for example in cases where the owner entity does not wish to proceed with transferring the money to the second Blockchain platform C2. The term channel here refers to the first smart contract SC1 and the second smart contract SC2, which operate in conjunction with the channel relay server 1. In another example, the owner entity may withdraw cryptocurrency from the channel back to their first address A1 on the first Blockchain platform C1, for example because the owner entity simply wishes to reduce the cryptocurrency balance in the channel, wherein the remaining balance in the channel is available to withdraw to either the first Blockchain platform C1 or the second Blockchain platform C2 in future.

In a step S30, the owner entity, in particular using the client computer 2, generates a channel-to-chain-one transaction T3. The channel-to-chain-one transaction T3 comprises the defined target address of the first smart contract SC1 and a third digital signature of the owner entity. The first address A1 of the owner entity is derivable from the third digital signature, or derivable from the transaction instruction of the channel-to-chain-one transaction T3. The second address A2 is derivable from the execution of the channel-to-chain-one transaction T3. Additionally, the channel-to-chain-one transaction T3 comprises an indication that a recall of cryptocurrency tokens is desired. The channel-to-chain-one transaction T3 can further comprise an indication of how many cryptocurrency tokens are to be returned to the possession of the owner entity. Additionally, the channel-to-chain-one data transaction T3 can further comprise an amount of cryptocurrency tokens that defines the remaining total balance of the defined type of cryptocurrency token should the recall be accepted. Additionally, the channel-to-chain-one data transaction T3 can further comprise a sequence number.

To ensure that the cryptocurrency tokens which the owner entity wishes to recall is still available for the owner entity, the channel relay server 1 is configured to check whether the owner entity is entitled to a recall. In particular, the channel relay server 1 is configured to determine a current balance of the owner entity and, if the current balance is less than the desired recall amount, to provide proof that the owner entity is not entitled to the recall. In another example, the channel relay server 1 is configured to determine whether the sequence number of the channel-to-chain-one data transaction T3 matches the next sequence number (e.g., the current sequence number plus one) of the channel in relation to the owner entity and, if the sequence number is a duplicate to the sequence number of another data transaction associated with the channel, or a currently not permitted sequence number of the channel, to provide proof that the owner entity is not entitled to the recall. If the channel relay server 1 does not provide such proof within a pre-determined time interval, the owner entity is entitled to the recall.

The specific steps involved in achieving this are detailed below. In such a manner, the owner entity is able to recall their cryptocurrency (i.e. withdraw it) even if the channel relay server 1 is unresponsive.

In a step S33, the channel relay server 1, in particular the processor 11, identifies data transactions on the first Blockchain platform C1, including at least all data transactions since the last confirmed recall of a previous channel-to-chain-one data transaction, related to both of: the first sender address A1 and the first smart contract SC1, the data transactions comprising confirmed data transactions and/or unconfirmed data transactions, each data transaction relating to a cryptocurrency token transfer and a timestamp.

In a step S34, the channel relay server 1, in particular the processor 11, identifies data transactions on the second Blockchain platform C2, including at least all data transactions since the last confirmed recall of a previous channel-to-chain-one data transaction, related to both of: the second address A2 and the second smart contract SC2, the data transactions comprising confirmed data transactions and/or unconfirmed data transactions, each data transaction relating to a cryptocurrency token transfer and a timestamp.

In a step S35, the channel relay server 1 determines a current total balance of the owner entity using the identified data transactions on the first Blockchain platform C1 and the identified data transactions on the second Blockchain platform C2. In particular, the current balance is determined using the defined number of cryptocurrency tokens of the identified data transactions on both the first Blockchain platform C1 and the second Blockchain platform C2 and by executing the identified data transactions in sequence according to the timestamp of each identified data transaction. In such a manner the channel relay server 1 replays transactions related to the cryptocurrency token transfer between the first address A1 of the owner entity and the second address A2 of the owner entity through the secure asset transfer system (channel) described herein to determine a current total balance of the owner entity held on the first smart contract SC1 and the second smart contract SC2.

Additionally, or alternatively, the current total balance is determined using one or two pre-calculated summaries of the same set of data transactions, i.e., the set of data transactions identified above on the first Blockchain platform C1 and/or the set of data transactions identified above on the second Blockchain platform C2. The pre-calculated summary is generated by the channel relay server 1 or the smart contracts SC1, SC2 (e.g., the first smart contract SC1 performs a pre-calculation of that subset of transactions related to the first Blockchain platform C1, and the second smart contract SC2 performs a pre-calculation of that subset of transactions related to the first Blockchain platform C2). The pre-calculated summary is generated in advance, i.e., before the channel-to-chain-one transaction T3 is generated.

In a step S36, the channel relay server 1 determines whether the current total balance of the owner entity held on the first smart contract SC1 and the second smart contract SC2 becomes negative should the recall of channel-to-chain-one data transaction be confirmed.

In a step S37, the channel relay server 1 transmits recall rejection information to the first smart contract SC1 if the current total balance is negative.

In a step S38, the first smart contract SC1 receives the recall rejection from the channel relay server 1, for example via a data transaction from an address of the channel relay server 1 on the first Blockchain platform C1. The first smart contract SC1 rejects the recall instructions as contained in the channel-to-chain-one transaction T3. In an example, the first smart contract SC1 may maintain a sequence number of the last confirmed recall of a previous channel-to-chain-one transaction, and in this case the sequence number remains the previous value.

In an optional step S39, the channel relay server 1 transmits an optional recall confirmation information to the first smart contract SC1 if the current total balance is non-negative.

In an optional step S391, the first smart contract SC1 receives the recall confirmation information from the channel relay server 1, for example via a data transaction from an address of the channel relay server 1 on the first Blockchain platform C1. The first smart contract SC1 performs the recall instructions as contained in the channel-to-chain-one transaction T3, in particular by making the cryptocurrency available to the owner. In an example, the first smart contract SC1 may further maintain a sequence number of the last confirmed recall of a previous channel-to-chain-one transaction, and in this case the sequence number is updated to the sequence number of the channel-to-chain-one transaction T3. Making the cryptocurrency available to the owner entity may comprise transferring a full or partial amount of cryptocurrency currently assigned to the owner entity to the address A1 of the owner entity, or generating one or more further function calls to one or more further smart contracts on the first Blockchain platform C1, the further function calls comprising instructions to transfer or credit the full or partial amount of cryptocurrency to the owner entity.

In an embodiment, the channel balance is updated according to the defined remaining total balance of the defined type of cryptocurrency token included in the channel-to-chain-one transaction T3. The update may be provided to the channel relay server 1, the first smart contract SC1 on the first Blockchain platform C1, and/or the second smart contract SC2 on the second Blockchain platform C2. The update may be provided in the form of or included in a transaction on the Blockchain platforms C1, C2.

Thereby, the first smart contract SC1 cannot reject the channel-to-chain-one transaction T3 unless recall rejection information is submitted to the first smart contract SC1, within a pre-defined time period, by the channel relay server 1.

In case the channel-to-chain-one transaction T3 should be rejected, a computer may join the channel relay server 1 in order to submit the recall rejection information. In particular, another client computer 2 is provided an incentive to join the channel relay server 1 for this purpose, because a malicious recall of cryptocurrency tokens from the system undermines the total asset value held in this system of its associated owner entity.

The recall rejection information (i.e. the proof submitted by the channel relay server 1 denying the withdrawal), as described above, must provide evidence (proof) that the total balance of the owner entity is negative. Therefore, the channel relay server 1 generates recall rejection information including, for example, a copy of or references to one or more transactions of the owner entity on the first Blockchain C1 and the second Blockchain C2, which prove that the total balance of the owner entity is negative. The transactions must complete the record of all transactions between the owner entity and the smart contracts SC1, SC2, at least since the last recall confirmation of a previous channel-to-chain-one data transaction. The transactions can be either validated to belong to the owner entity by their digital signature, or validated to be transmitted from the channel relay server 1, in case of consensus being affirmatively established, or in case of a valid proof being provided. Additionally, or alternatively, the recall rejection information may include evidence of an incorrect remaining total balance of the channel provided in the channel-to-chain-one data transaction T3. Optionally, the correct current total balance may be provided to the first smart contract SC1 as part of the recall rejection information. The recall rejection information may be generated in a similar manner as previously described for the scenario described herein relating to proving that the total balance becomes negative. Additionally, or alternatively, the recall rejection information can include evidence of two transactions with the same sequence number. Additionally, or alternatively, the recall rejection information can include evidence of the sequence number of the channel-to-chain-one data transaction T3 being a currently not permitted sequence number with respect to the current sequence number maintained in the channel, (for example, the permitted sequence number must be the current sequence number plus one). In an example, the evidence includes the sequence number of the channel-to-chain-one data transaction T3 and a proof (e.g., a digital proof such as a zero knowledge proof) of the current sequence number of the channel using one or more of: a checkpoint on the second Blockchain C2, preferably stored in a smart contract on the first Blockchain platform C1, the checkpoint being sufficiently recent, for example the latest, the last sequence number of a data transaction associated with the channel in particular in relation to the owner entity, successfully executed on the second Blockchain platform C2, for example stored in the second smart contract SC2, associated with the checkpoint, and the latest sequence number of a data transaction associated with the channel in particular in relation to the owner entity, successfully executed on the first Blockchain platform C1.

If the channel relay server 1 does not provide the recall information (i.e. either the recall confirmation information or the recall rejection information) within a pre-defined time period, then the first smart contract SC1 is configured to execute the recall according to the channel-to-chain-one transaction T3. Thereby, the owner entity can recall their cryptocurrency from the first smart contract SC1, even if the channel relay server 1 is unresponsive.

In an embodiment, the channel relay server 1 further identifies, on the first Blockchain platform C1, the second Blockchain platform C2, or both, checkpoint information related to one or more checkpoints. Each checkpoint comprises commitment data of the first smart contract SC1 or the second smart contract SC2, respectively. The checkpoint may further comprise a reference to a previous checkpoint. The commitment data comprises a provable digest of the state of the smart contracts SC1, SC2, in particular a state of the internal data store of the smart contracts SC1, SC2 at a time-point corresponding to a timestamp of the particular checkpoint. A provable digest is, for example, a merkle root or a cryptographic accumulator. The proof (in relation to the provable digest) first refers to a specific checkpoint and gives the key and value pair to be proved, and the proof data and the proof algorithm. The proof data and the proof algorithm can deduce the key and value from the provable digest if and only if the proof is valid.

In comparison, channel-to-chain-two data transactions may be designed to be executed or rejected immediately upon receiving by the second smart contract SC2 on the second Blockchain platform C2, without any other steps involving the channel relay server 1. To prevent a double-spending attack by a client computer(s) 2 submitting channel-to-chain-one transactions and channel-to-chain-two transactions at or around the same time, and to make sure that all the cryptocurrency tokens belonging to the owner entity is available for withdrawal by a channel-to-chain-two data transaction, additional information about a channel-to-chain-one transaction T3 may be transmitted to the second Blockchain platform C2. In one example, recall confirmation information is transmitted to the second smart contract SC2 on the second Blockchain platform C2 for each channel-to-chain-one data transaction T3, much earlier than the optional recall confirmation information is transmitted to the first Blockchain platform C1. In another example, a copy of each channel-to-chain-one transaction T3 is configured to be transmitted to the second smart contract SC2 on the second Blockchain platform C2, by a channel relay computer 1A, or by the client computer 2, and the amount of cryptocurrency tokens specified in the channel-to-chain-one data transaction is temporarily locked in the second smart contract SC2, until a recall rejection information of the channel-to-chain-one data transaction is transmitted to the second smart contract SC2 of the second Blockchain platform C2, after the recall rejection information is confirmed on the first Blockchain platform C1.

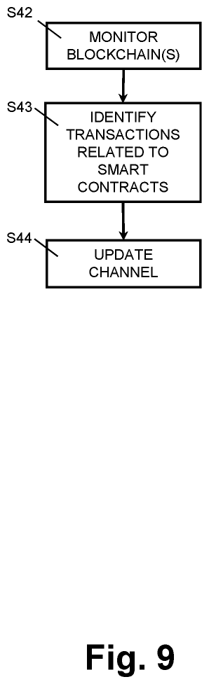

FIG. 9 shows a flow diagram including a number of exemplary steps S42, S43, S44 for monitoring a Blockchain platform C1, C2 and updating a channel accordingly. The steps S42, S43, S44 may be performed independently of other steps described herein with reference to other flow diagrams. Some or all of the steps S42, S43, S44 may, however, also be performed prior to, in between, or subsequent to the steps described herein with reference to other flow diagrams. The steps S42, S43, S44 may be performed on demand or performed recurrently. For example, the steps S42, S43, S44 may be performed every time a new block is added, or performed for each transaction included in a new block, on the first Blockchain C1 and/or the second Blockchain platform, in particular for each transaction directed to the first smart contract SC1 and/or the second smart contract SC2, respectively. At least some of the steps may be performed in a different sequence than shown. Some of the steps may be performed simultaneously.

The steps are performed by the channel relay server 1. The steps may, additionally or alternatively, also be performed by the client computer 2 and/or the RPC server(s) 4.

In step S42, the first Blockchain platform C1 and/or the second Blockchain platform are monitored. As described herein with reference to other steps, this may include monitoring one or more blocks of the Blockchain platforms C1, C2, in particular most recently added blocks, and/or monitoring a transaction pool of the respective Blockchain platforms C1, C2.

In step S43, one or more data transactions are identified on the Blockchain platforms C1, C2 related to the first and/or second smart contracts SC1, SC2. For example, chain-one-to-channel data transactions T1 are identified.

In step S44, the channel 5 is updated according to the type of data transaction and/or the information included in the data transactions. In particular, the channel balance 54 of the channel 5 is updated according to the data transactions. For example, the channel balance 54 may be credited with the number of tokens of the cryptocurrency included in the chain-one-to-channel data transaction T1. The crediting may be contingent on the confirmation of the chain-one-to-channel data transaction T1.

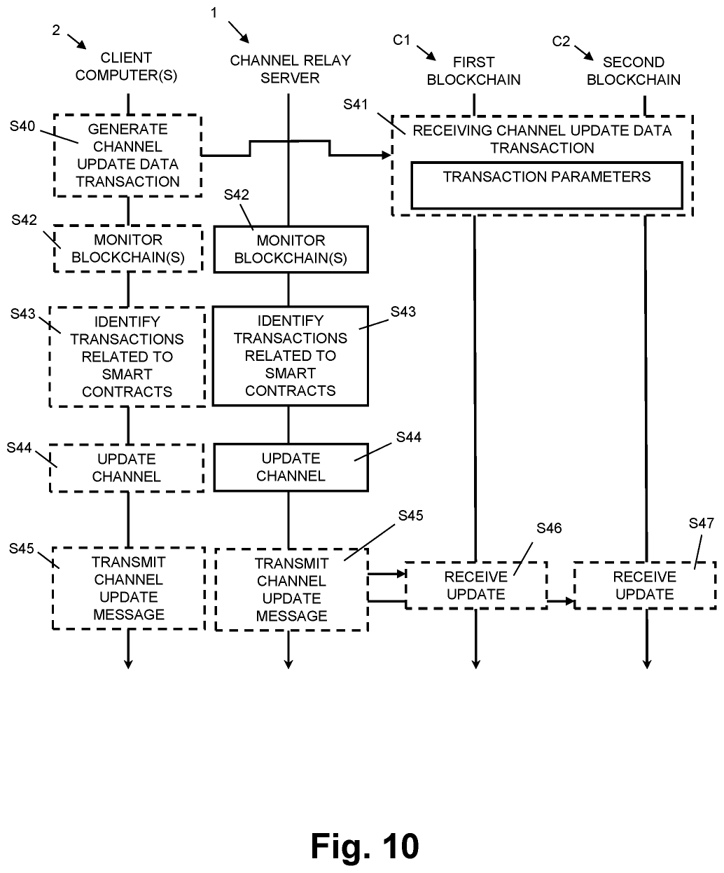

FIG. 10 shows a flow diagram illustrating a number of exemplary steps S40-S47 for updating the channel. At least some of the steps S40-S47 are optional. The steps S42-S44 are described above with reference to FIG. 9, and may be performed by the channel relay server and/or the client computer 2. Step S45 is optional and may be performed either by the channel relay server 1 or the client computer 2.

In step S40, which is optional, a channel update data transaction is generated. The channel update data transaction is a transaction on the first Blockchain platform C1 and/or the second Blockchain platform C2 which contains information which may be relevant for updating, maintaining or establishing the total balance on the channel. The channel update data transaction may be, for example, the chain-one-to-channel data transaction T1, the chain-two-confirmation data transaction T2, the channel-to-chain-one data transaction T3, or the channel-to-chain-two data transaction T4. The channel update data transaction may include a lock instruction, an unlock instruction, and/or a withdraw instruction. The channel update data transaction may include a sequence number. The channel update data transaction includes transaction parameters.

The channel update data transaction is transmitted on the first and/or second Blockchain platform C1, C2. The channel update data transaction may be addressed and/or otherwise directed or call the first smart contract SC1 and/or the second smart contract SC2.

In step S41, the channel update data transaction is received on the first Blockchain platform C1 and/or the second Blockchain platform C2. The effect of receiving the channel update data transaction depends on which type of transaction it is (we refer to the different types of data transactions mentioned in step S40), and which smart contract SC1, SC2 receives the channel update data transaction.

Steps S42-S44 are performed as described above with reference to FIG. 9.

In step S45, which is optional, may be performed subsequent to, prior to, or simultaneously to, step S44, one or more channel update message(s) are generated and transmitted to the first Blockchain platform C1 and/or the second Blockchain platform C2. The channel update message includes information to update the total balance and as such may include one or more changes in the total balance as recorded by or initiated by one or more data transactions on the first and/or second Blockchain platforms. The channel update message may, additionally or alternatively, provide an indication of a current total balance. The channel update message may be transmitted on the first Blockchain platform and/or the second Blockchain platform as a transaction. The transaction on the Blockchain platform(s) is directed to the first and/or second smart contract, respectively. The channel update message may also include a message transmitted using the communication network to the client computer 2, for example using a middleware and/or the RPC server 4.

The channel update message may be implemented as, or be included in, a transaction on the first Blockchain platform C1 and/or the second Blockchain platform C2. The channel update message may be implemented as, include, or be included in, the transaction confirmation information, the chain-two-confirmation data transaction T2, the witness data transaction, recall confirmation information, or recall rejection information.

The channel update message may comprise a reference to and/or a copy of the chain-one-to-channel data transaction T1 (in particular as included in the transaction confirmation information), a reference to and/or a copy of the channel-to-chain-one data transaction T3 (in particular as included in the recall confirmation information), a reference to and/or a copy of a channel update data transaction (in particular as included in the recall rejection information or for providing proof of an invalid sequence number and/or for providing proof of an invalid channel-to-chain-one data transaction T3).

In step S46, which is optional, the channel update message is received on the first Blockchain platform C1, in particular by the first smart contract. The channel update message is configured such that the first smart contract updates, in its internal ledger, information related to the owner entity, in particular the total balance associated with the owner entity.

In step S47, which is optional, the channel update message is received on the second Blockchain platform C1, in particular by the second smart contract. The channel update message is configured such that the second smart contract updates, in its internal ledger, information related to the owner entity, in particular the total balance associated with the owner entity.

The channel update message may further be received by the client computer 2, in particular if the channel update message was transmitted by the channel relay server 1. The client computer 2 uses the channel update message to update and/or store the total balance associated with the owner entity. Alternatively, the channel update message may be received by the channel relay server 1, in particular if the channel update message was transmitted by the client computer 2.

1. A computer implemented method for facilitating a secure transfer of cryptocurrency between two Blockchain platforms, the method comprising:
monitoring, by a processor of a computerized channel relay server, a first Blockchain platform for a chain-one-to-channel data transaction, the chain-one-to-channel data transaction comprising: a defined target address of a first smart contract on the first Blockchain platform, a defined number of tokens of a particular cryptocurrency, and a first digital signature, wherein a first address of an owner entity is either derivable from the first digital signature, or derivable from transaction instructions included in the chain-one-to-channel data transaction;
verifying, by the processor, whether the chain-one-to-channel data transaction has been confirmed on the first Blockchain platform; and
transmitting, by the processor, transaction confirmation information to a second smart contract on a second Blockchain platform, in case of affirmative confirmation of the chain-one-to-channel data transaction.

2. The method of claim 1, the method further comprising:
monitoring, by a plurality of channel relay computers of the channel relay server, the first Blockchain platform for the chain-one-to-channel data transaction;
establishing, by the plurality of channel relay computers, a consensus as to whether the chain-one-to-channel data transaction has been confirmed; and
transmitting, by at least one of the channel relay computers, the transaction confirmation information to the second smart contract, in case of affirmative confirmation in the form of an affirmative consensus.

3. The method of claim 1, further comprising:
updating, using the processor, in a memory of the channel relay server, a current total balance indicative of a number of tokens associated with the owner entity, using a previously stored total balance and the defined number of tokens.

4. The method of claim 1, further comprising the steps of:
monitoring, using the processor, the first Blockchain platform for a channel-to-chain-one data transaction comprising: the defined target address of the first smart contract, and a third digital signature, wherein the first address of the owner entity is either derivable from the third digital signature, or derivable from the transaction instructions of the channel-to-chain-one data transaction, wherein a second address on the second Blockchain platform is derivable from the execution of the channel-to-chain-one data transaction;
identifying, using the processor, one or more of:
data transactions on the first Blockchain platform, including at least all data transactions since a last confirmed recall of a previous channel-to-chain-one data transaction, related to both of: the first address and the first smart contract, the data transactions comprising confirmed data transactions and/or unconfirmed data transactions, each of the data transactions relating to a cryptocurrency token transfer and having a timestamp; or
a pre-calculated transaction summary of the data transactions;
identifying, using the processor, one or more of:
data transactions on the second Blockchain platform, including at least all data transactions since the last confirmed recall of the previous channel-to-chain-one data transaction, related to both of: the second address and the second smart contract, the data transactions comprising confirmed data transactions and/or unconfirmed data transactions, each data transaction relating to a cryptocurrency token transfer and a timestamp; or
a pre-calculated transaction summary of the aforementioned data transactions;
determining a current total balance of the owner entity using the identified data transactions, or the pre-calculated transaction summaries on the first Blockchain platform, and the identified data transactions on the second Blockchain platform, or the pre-calculated transaction summaries on the second Blockchain platform;
transmitting, using the processor, recall rejection information to the first smart contract if the current total balance is negative.

5. The method of claim 4, wherein the channel-to-chain-one data transaction further comprises a defined amount of cryptocurrency tokens to be returned to the first address of the owner entity and/or an amount of cryptocurrency tokens defining a remaining total balance of the defined type of cryptocurrency token should the recall be confirmed.

6. The method of claim 1, wherein the computerized channel relay server implements, using the processor, a node of the first Blockchain platform, and wherein monitoring the first Blockchain platform comprises identifying, using the processor, the chain-one-to-channel data transaction in one or more of the following: in a transaction pool related to the first Blockchain platform or in a block of the first Blockchain platform.

7. The method of claim 1, wherein the computerized channel relay server comprises a plurality of channel relay computers, and a subset of the channel relay computers are designated as witnesses, wherein the method further comprises:
submitting, using the processor of a particular one of the channel relay computers designated as a witness, a witness data transaction to the second Blockchain, causing the transmitting of the transaction confirmation information, the witness data transaction including a digital signature of the witness and at least part of the chain-one-to-channel data transaction, or an identifier thereof, and authorization information.

8. The method of claim 7, further comprising:
monitoring, by the processors of the channel relay computers, the second Blockchain platform for a chain-two-confirmation data transaction matching the chain-one-to-channel data transaction, and
establishing, in the channel relay computers, a consensus amongst the channel relay computers as to whether the transaction confirmation information is to be transmitted for the chain-one-to-channel data transaction, dependent on the correct execution of the chain-two-confirmation data transaction on the second Blockchain platform.

9. The method of claim 1, wherein the computerized channel relay server implements a node of the second Blockchain platform, and wherein monitoring, using the processor, the second Blockchain platform comprises identifying, using the processor, the chain-two-confirmation data transaction in one or more of the following: in a transaction pool related to the second Blockchain platform or in a block of the second Blockchain platform.

10. The method of claim 1, wherein transmitting the transaction confirmation information to the second smart contract on the second Blockchain platform comprises:
determining, using the processor, whether the chain-one-to-channel data transaction has been included in checkpoint information of the first Blockchain platform and/or of the first smart contract, the checkpoint information related to one or preferably two checkpoints provided by the first Blockchain platform and/or provided by the first smart contract, respectively; and
generating, using the processor, a chain-two-confirmation data transaction on the second Blockchain platform, causing the transmitting of the transaction confirmation information, the chain-two-confirmation data transaction comprising at least part of the chain-one-to-channel data transaction, or an identifier thereof, and authorization information.

11. The method of claim 1, further comprising:
identifying, on one or more of: the first Blockchain platform or the second Blockchain platform, checkpoint information related to one or more checkpoints of the first Blockchain platform or of the second Blockchain platform, the checkpoint information comprising commitment data of the first smart contract, the commitment data comprising a state of the first smart contract corresponding to a timestamp included in the checkpoint information;
confirming, using the processor, the chain-one-to-channel data transaction using the checkpoint information; and
generating, using the processor the transaction confirmation information, in case of affirmative confirmation of the chain-one-to-channel data transaction.

12. The method of claim 1, wherein determining whether the chain-one-to-channel data transaction and the chain-two-confirmation data transaction match comprises comparing, using the processor:
a first identifier included in the chain-one-to-channel data transaction and a second identifier included in the chain-two-confirmation data transaction;
or, in case the chain-two-confirmation data transaction includes part of the chain-one-to-channel data transaction, a first digest computed from a particular part of the chain-one-to-channel data transaction included in the chain-two-confirmation data transaction, and a second digest computed from the particular part of the chain-one-to-channel data transaction.

13. A computer system for facilitating a secure digital asset transfer between two Blockchain platforms, the computer system comprising a processor configured to implement a channel relay server by executing a method comprising the steps of:
monitoring, by a processor of a computerized channel relay server, a first Blockchain platform for a chain-one-to-channel data transaction, the chain-one-to-channel data transaction comprising: a defined target address of a first smart contract on the first Blockchain platform, a defined number of tokens of a particular cryptocurrency, and a first digital signature, wherein a first address of an owner entity is either derivable from the first digital signature, or derivable from transaction instructions included in the chain-one-to-channel data transaction;
verifying, by the processor, whether the chain-one-to-channel data transaction has been confirmed on the first Blockchain platform; and
transmitting, by the processor, transaction confirmation information to a second smart contract on a second Blockchain platform, in case of affirmative confirmation of the chain-one-to-channel data transaction.

14. The computer system of claim 13, the computer system comprising a plurality of distributed channel relay computers communicatively coupled to each other, wherein each channel relay computer comprises a processor configured to:
monitor the first Blockchain platform for the chain-one-to-channel data transaction addressed to the first smart contract,
exchange one or more data messages with other channel relay computers to establish in the computer system a consensus as to whether the chain-one-to-channel data transaction has been confirmed; and
transmit the transaction confirmation information to the second smart contract in case of the consensus being affirmatively established.

15. A system for facilitating a secure transfer of digital assets between two Blockchain platforms, the system comprising a computer system according to claim 13 and one or more client computers associated with an owner entity, the client computer(s) comprising a processor configured to:
generate a chain-one-to-channel data transaction on a first Blockchain platform, the chain-one-to-channel data transaction comprising: a defined target address of a first smart contract, a defined number of tokens of a particular cryptocurrency, and a first digital signature, wherein a first address of the owner entity is derivable either from the first digital signature or from transaction instructions of the chain-one-to-channel data transaction.

16. The system of claim 15, wherein the processor of the client computer is configured to generate a chain-two-to-channel data transaction on the second Blockchain platform, the chain-two-to-channel data transaction comprising: the defined target address of the second smart contract, a defined number of tokens of the particular cryptocurrency, and a second digital signature providing an authorization of the owner entity.

17. The system of claim 1, the system further comprising a first smart contract on the first Blockchain platform configured to:
receive the chain-one-to-channel data transaction from the first address associated with the owner entity comprising the defined number of tokens of a particular cryptocurrency, and
generate and store, using data contained in the chain-one-to-channel data transaction, the pair of the first address and the second address of the owner entity on the first Blockchain.

18. The system of claim 15, the system further comprising a second smart contract on the second Blockchain platform configured to:
receive the chain-two-confirmation data transaction comprising at least part of the chain-one-to-channel data transaction, or an identifier thereof, and authorization information; and
generate and store, using the defined number of tokens of the chain-one-to-channel data transaction, a current balance of cryptocurrency tokens associated with the owner entity on the second Blockchain.

19. A method for securely transferring cryptocurrency tokens between two Blockchain platforms, the method comprising the steps of:
generating, in a processor of a computer, a chain-one-to-channel data transaction on a first Blockchain platform, the chain-one-to-channel data transaction comprising: a defined target address of a first smart contract, a defined number of tokens of a particular cryptocurrency, and a first digital signature, wherein a first address of an owner entity is derivable either from the first digital signature or from transaction instructions of the chain-one-to-channel data transaction; and
generating, in the processor, a channel-to-chain-two data transaction on a second Blockchain platform, the channel-to-chain-two data transaction comprising: a defined target address of a second smart contract and a digital signature providing an authorization of the owner entity.

20. The method according to claim 19, further comprising the step of:
transmitting, using the processor, transaction confirmation information in the form of a chain-two-confirmation data transaction on the second Blockchain platform addressed to the second smart contract, wherein the chain-two-confirmation data transaction comprises at least one of: a sequence number, a proof of inclusion of the sequence number in a checkpoint, a proof of the inclusion of the chain-one-to-channel data transaction in a checkpoint, or a proof that the chain-one-to-channel data transaction has been transmitted on the first Blockchain platform, wherein the sequence number is a global counter associated with at least one of: the owner entity and/or the smart contracts.

21. The method according to claim 19, further comprising the step of:
generating, in the processor, a channel-to-chain-one data transaction comprising: a defined amount of cryptocurrency tokens to be returned to the first address of the owner entity and/or an amount of cryptocurrency tokens defining a remaining total balance of the defined type of cryptocurrency token should the recall be confirmed.

22. A computer configured to perform the steps according to the method of claim 19.

23. A computer program product comprising computer program code, which directs a processor of a computerized channel relay server to perform a method according to claim 1.

24. A computer program product comprising computer program code, which directs a processor of a computer to perform a method according to claim 19.
